(19) United States
(12) Patent Application Publication
(10) Pub. No.: US 2015/0063251 A1
(43) Pub. Date: Mar. 5, 2015

(54) METHODS AND APPARATUS FOR EXTENDING A REVERSE DIRECTION GRANT ON A WIRELESS NETWORK

(71) Applicant: QUALCOMM Incorporated, San Diego, CA (US)

(72) Inventor: Alfred Asterjadhi, San Diego, CA (US)

(21) Appl. No.: 14/454,223

(22) Filed: Aug. 7, 2014

Related U.S. Application Data
(60) Provisional application No. 61/872,334, filed on Aug. 30, 2013.
(60) Provisional application No. 61/899,841, filed on Nov. 4, 2013.
(60) Provisional application No. 61/900,936, filed on Nov. 6, 2013.
(60) Provisional application No. 61/976,478, filed on Apr. 7, 2014.

(51) Int. Cl. H04W 74/04

(52) U.S. Cl. CPC H04W 74/04
USPC 370/329

(57) ABSTRACT

Systems, methods, and devices for extending the duration of a reverse direction grant are described herein. In some aspects, a method of wireless communication includes transmitting, via a first device, a first message, the first message indicating a duration of a transmission opportunity of the first device, receiving, via the first device, a second message; and decoding, via the first device, the second message to determine a new duration of the transmission opportunity.

### CROSS-REFERENCE TO RELATED APPLICATIONS

This application claims the benefit of U.S. Provisional Application No. 61/872,334, filed Aug. 30, 2013, and entitled “METHODS AND APPARATUS FOR EXTENDING A REVERSE DIRECTION GRANT ON A WIRELESS NETWORK,” and to U.S. Provisional Application No. 61/899,841, filed Nov. 4, 2013, and entitled “METHODS AND APPARATUS FOR EXTENDING A REVERSE DIRECTION GRANT ON A WIRELESS NETWORK,” and to U.S. Provisional Application No. 61/900,936, filed Nov. 6, 2013, and entitled “METHODS AND APPARATUS FOR EXTENDING A REVERSE DIRECTION GRANT ON A WIRELESS NETWORK,” and to U.S. Provisional Application No. 61/976,478, filed Apr. 7, 2014, and entitled “METHODS AND APPARATUS FOR EXTENDING A REVERSE DIRECTION GRANT ON A WIRELESS NETWORK,” all of which are assigned to the assignee hereof. The disclosures of these prior applications are considered part of this application, and are hereby incorporated by reference in their entirety.

### BACKGROUND

1. Field

The present application relates generally to wireless communications, and more specifically to systems, methods, and devices for allocating a wireless transmission medium between a first and a second wireless device.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

A transmission medium in a wireless network may have a limited capacity. The transmission medium capacity may be allocated to nodes of the wireless network using a variety of protocols or methods. In some instances, a portion of the medium's transmission capacity may be allocated to a wireless node, but may be in excess of the transmission capacity needed by the node at a particular time. This may result in some portions of the medium's transmission capacity being unused. Thus, improved systems, methods, and devices for allocating transmission capacity in a wireless network are desired.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between first and second devices in a wireless network. In an embodiment, the first and second devices may be access points and stations in the wireless network.

One innovative aspect includes a method A method of wireless communication. The method includes transmitting, via a first device, a first message, the first message indicating a duration of a transmission opportunity of the first device, receiving, via the first device, a second message; and decoding, via the first device, the second message to determine a new duration of the transmission opportunity. In some aspects, the method also includes generating the first message as one of a request-to-send message, a ps-poll frame, or a trigger frame. In some aspects, the method includes decoding the second message as a clear-to-send message, or as a request-to-send message. In some aspects, the method includes transmitting a third message indicating whether a second device has permission to extend the duration of the transmission opportunity. In some aspects, the method includes generating the first message to indicate whether the first device grants permission to utilize at least a portion of the transmission opportunity to relay data transmitted by the first device. In some aspects, permission is indicated in an order field or a relayed frame field of the first message. Some aspects of the method also include decoding the second message to determine whether an explicit or implicit acknowledgment procedure is used for the relayed data, transmitting a data packet during the transmission opportunity; and determining whether the data packet is acknowledged based on the acknowledgment procedure. In some aspects, the method includes determining a NAV expiration time based on the duration field of the second message; determining the acknowledgement procedure is explicit if the determined NAV expiration time is different than a NAV expiration time indicated by the duration field of the first message; and determining the acknowledgment procedure is implicit if the determined NAV expiration time is the same as the NAV expiration time indicated by the duration field of the first message.

Another aspect disclosed is an apparatus for wireless communication. The apparatus includes a transmitter configured to transmit a first message, the first message indicating a duration of a transmission opportunity of the apparatus, a receiver configured to receive a second message; and a processing system configured to decode the second message to determine a new duration of the transmission opportunity. In some aspects, the transmitter is further configured to transmit a third message indicating whether a second device has permission to extend the duration of the transmission opportunity. In some aspects, the processing system is further configured to generate the first message to indicate whether the first device grants permission to utilize at least a portion of the transmission opportunity to relay data transmitted by the first device. In some aspects, the processing system is further configured to indicate whether the permission is granted in an order field or a relayed frame field of the first message. In some aspects, the processing system is further configured to decode the second message to determine whether an explicit or implicit acknowledgment procedure is used for the relayed data, and determine whether a transmitted data packet is acknowledged based on the determined acknowledgment procedure. In some aspects, the processing system is further configured to determine a NAV expiration time based on the duration field of the second message, determine the acknowledgement procedure is explicit if the determined NAV expiration time is different than a NAV expiration time indicated by the duration field of the first message; and determine the acknowledgment procedure is implicit if the determined NAV expiration time is the same as the NAV expiration time indicated by the duration field of the first message.

Another aspect disclosed is a method of wireless communication. The method includes receiving, via a first device, a first message, decoding the first message to determine a duration of a transmission opportunity of a second device, generating, via the first device, a second message, the second message indicating a new duration of the transmission opportunity; and transmitting the second message. In some aspects, the method also includes receiving a third message; and decoding the third message to determine whether the first device has permission to extend the duration of the transmission opportunity. In some aspects, the method also includes decoding the first message to determine whether permission is granted to relay data transmitted by the second device during the transmission opportunity. In some aspects, the method also includes generating the second message to indicate an acknowledgment procedure for the relayed data, receiving data from the second device; and acknowledging the data based on the indicated acknowledgment procedure.

Some aspects of the method include determining use of an explicit acknowledgment procedure for the received data; and generating the second message to indicate an extended NAV duration relative to a NAV duration indicated by the first message based on a duration field of the second message.

Some aspects of the method also include determining a duration field of the second message based on an estimated time for a transmission of the data received from the second device, the duration of the transmission opportunity of the second device, and an amount of time remaining in the transmission opportunity, and indicating the extended NAV duration in the duration field of the second message.

Some aspects of the method also include determining use of an implicit acknowledgment procedure for the received data; and generating the second message to indicate an unchanged NAV duration relative to a NAV duration indicated by the first message based on a duration field of the second message. In some aspects, the method also includes transmitting a request-to-send message to a third device in response to receiving the data if the second message indicates an implicit acknowledgment procedure.

Another aspect disclosed is an apparatus for wireless communication. The apparatus includes a receiver configured to receive a first message, a processing system configured to decode the first message to determine a duration of a transmission opportunity of a second device, and to generate a second message indicating a new duration of the transmission opportunity; and a transmitter configured to transmit the second message. In some aspects, the processing system is further configured to decode the first message as one of a request-to-send message, a ps-poll frame, or a trigger frame. In some aspects, the processor is further configured to decode the first message to determine whether permission is granted to relay data transmitted by the second device during the transmission opportunity. In some aspects, the processor is further configured to generate the second message to indicate an acknowledgment procedure for the relayed data, receive data from the second device; and acknowledge the data based on the indicated acknowledgment procedure. In some aspects of the apparatus, the processor is further configured to determine use of an explicit acknowledgment procedure for the received data; and generate the second message to indicate an extended NAV duration relative to a NAV duration indicated by the first message.

In some aspects of the apparatus, the processor is further configured to determine a duration field of the second message based on an estimated time for a transmission of the data received from the second device, the duration of the transmission opportunity of the second device, and an amount of time remaining in the transmission opportunity, and indicate the extended NAV duration in the duration field of the second message. In some aspects of the apparatus, the processor is further configured to determine use of an implicit acknowledgment procedure for the received data; and generate the second message to indicate an unchanged NAV duration relative to a NAV duration indicated by the first message based on a duration field of the second message. In some aspects of the apparatus, the transmitter is further configured to transmit a request-to-send message to a third device in response to receiving the data if the second message indicates an implicit acknowledgment procedure.

### BRIEF DESCRIPTION OF THE DRAWINGS

FIG. 1 shows an exemplary wireless communication system 100. The wireless communication system may operate pursuant to a wireless standard, for example any one of the 802.11 standards.

FIG. 2 shows an exemplary functional block diagram of a wireless device that may be employed within the wireless communication system of FIG. 1.

FIG. 3A is a timing diagram of a message exchange allocating a transmission medium between a first and second wireless device.

FIG. 3B is a timing diagram of a message exchange allocating a transmission medium between a first and second wireless device.

FIG. 3C is a timing diagram of one embodiment of a message exchange allocating a data communications medium between an access point and a station.

FIG. 3D shows a format of an exemplary request-to-send (RTS) frame.

FIG. 3E-1 shows a format of an exemplary acknowledgment frame.

FIG. 3E-2 shows an alternative format of a frame control field of the acknowledgment frame of FIG. 3E-1.

FIG. 3F is a timing diagram of one embodiment of a message exchange allocating a data communications medium between an access point and a station.

FIG. 3G is a timing diagram of one embodiment of a message exchange allocating a data communications medium between an access point and a station.

FIG. 3H is a timing diagram of one embodiment of a message exchange allocating a data communications medium between an access point and a station.

FIG. 3I is a timing diagram of one embodiment of a message exchange allocating a data communications medium between an access point and a station.

FIG. 4A is a flowchart of a process for allocating a data communications medium between a first and second wireless device on a wireless network.

FIG. 4B is a functional block diagram of an exemplary device that may be employed within a wireless communication system.

FIG. 5A is a flowchart of a process for allocating a data communications medium between a first and second wireless device on a wireless network.

FIG. 5B is a functional block diagram of an exemplary device that may be employed within a wireless communication system.

FIG. 6A is a flowchart of a process for allocating a data communications medium between a first and second wireless device on a wireless network.

FIG. 6B is a functional block diagram of an exemplary device that may be employed within a wireless communication system.

FIG. 7A is a flowchart of a process for allocating a data communications medium between a first and second wireless device on a wireless network.

FIG. 7B is a functional block diagram of an exemplary device that may be employed within a wireless communication system.

FIG. 8A is a flowchart of a process for allocating a data communications medium between a first and second wireless device on a wireless network.

FIG. 8B is a functional block diagram of an exemplary device that may be employed within a wireless communication system.

FIG. 9A is a flowchart of a process for allocating a data communications medium between a first and second wireless device on a wireless network.

FIG. 9B is a functional block diagram of an exemplary device that may be employed within a wireless communication system.

FIG. 10A is a flowchart of a process for allocating a data communications medium between a first and second wireless device on a wireless network.

FIG. 10B is a functional block diagram of an exemplary device that may be employed within a wireless communication system.

FIG. 11A is a flowchart of a process for allocating a data communications medium between a first and second wireless device on a wireless communication network.

FIG. 11B is a functional block diagram of an exemplary device 1150 that may be employed within the wireless communication system 100.

FIG. 12A is a flowchart of a process for relaying data over a wireless communications network.

FIG. 12B is a functional block diagram of an exemplary device 1250 that may be employed within the wireless communication system 100.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals in a sub-gigahertz band may be transmitted according to the 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a WiFi (e.g., IEEE 802.11 protocol such as 802.11) compliant wireless link to obtain general connectivity to the Internet or to other wide area networks. In some implementations a STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement any one of the 802.11 standards, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

Some embodiments of wireless network may experience asymmetric traffic and data rates. For example, because access points may be able to transmit with relatively high power, transmissions from a second wireless device may achieve a high data rate for downlink traffic. In some embodiments, stations may be of relatively lower power and may sustain lower data rates for uplink traffic.

Additionally, some stations may be power constrained. To minimize a station's power usage, it may be desirable to improve a station's ability to operate in a sleep state to extend the battery life of the station. One method to increase the time a station may operate in a sleep state is to reduce the time required for a station to uplink data to a second wireless device.

In some wireless networks, for example 802.11 networks, a station may transmit data by either transmitting during a contention time period or by reserving a transmission opportunity during a contention free time period. If data is transmitted during a contention time period, a collision may result from the transmission. A collision may then require a station to delay transmission according to one or more collision resolution methods. This may inhibit the station's ability to enter a sleep state until the collision is resolved and the data is successfully transmitted.

If the station reserves a transmission opportunity during a contention free time period, the station may also be inhibited from entering a sleep state for a time period. For example, one method of reserving a content free transmission opportunity is to transmit a request-to-send message. A second wireless device controlling access to the medium during the contention free period may respond with a clear-to-send message. This may then provide a transmission opportunity for the station. However, transmitting the request-to-send message, if transmitted during a contention period, may result in a collision that, as discussed above, may consume additional time to resolve. The station may also be inhibited from entering a sleep state until it receives at least the clear to send message from the access point, also inhibiting the station's ability to enter a sleep state.

Proposed herein are methods, apparatus, and systems that provide for a first wireless device to request a reverse direction grant (RDG) from a second wireless devices to improve the utilization of a wireless data communications medium during a transmission opportunity (TXOP) of the second wireless device. The reverse direction protocol enables the second wireless device to grant permission for a first wireless device to transmit data during a transmission opportunity time period reserved for transmissions of the second wireless device. By utilizing at least a portion of the second wireless device's transmission opportunity, the time necessary for a first wireless device to uplink data to a second wireless device may be reduced. This reduction in time can provide for longer sleep periods and thus a longer battery life of the first wireless device. While in the following description of the disclosed embodiments the first wireless device may be referred to as the station and the second wireless device will be referred to as the access point, those skilled in the art will appreciate that the methods described herein may be applied to any two types of wireless devices.

In an embodiment, the amount of data a wireless device is waiting to send may be insufficient to consume all of the time available in the wireless device's transmission opportunity when the waiting data is transmitted. The time remaining in the transmission opportunity after all of its own data has been sent may be allocated to one or more other wireless devices. An ability for another wireless device to request use of a portion of the wireless device's transmission opportunity is described below.

A station operating on a wireless network may awake from a sleep state and send a message to a second wireless device to determine if the second wireless device has any data waiting to be sent to the station. In an embodiment, the message sent to the second wireless device is a “ps-poll” message or in general, a trigger frame. Proposed is a request message sent from a first wireless device to a second wireless device that includes an indication that the first wireless device is requesting a reverse direction grant from the second wireless device. This request message may be considered a reverse direction grant request. If granted, the first wireless device is permitted to transmit data during a portion of a transmission opportunity of the second wireless device.

In another embodiment the reverse direction grant request may be implicit and agreed to beforehand (for example during an association) between the first and second wireless devices. In some aspects, whether the first and/or second wireless device will support the reverse direction grant request may be negotiated between the first and/or second wireless device before the reverse direction grant request is transmitted. For example, the first and second wireless devices may exchange management frames to negotiate whether reverse direction grant requests will be exchanged. In some aspects, the negotiation may define time periods when a device may provide a reverse direction grant. In some aspects, these time periods may be repeating or periodic.

In one embodiment, the request message is a “ps-poll” or the trigger frame. In this embodiment, the reverse direction grant request can be indicated by a “more data” bit or an uplink data indication included in the ps-poll message. In one aspect, this indication may be a single bit specifying whether or not the first wireless device has buffered uplink data. In other aspects, more bits may be used as an indication that the first wireless device has buffered uplink data. The multiple bits may be used to indicate not only that the first wireless device has buffered uplink data, but also the amount of data buffered for uplink. In one aspect, the multiple bit indication may indicate an estimated transmission time as a multiple of a time unit. For example in an aspect utilizing a 9 bit indication, the first wireless device can indicate that up to 512 TUs (e.g., symbols) may be necessary to transmit its buffered uplink data.

By utilizing a portion of a second wireless device's transmission opportunity to transmit data, the first wireless device may transmit with reduced risk of delays associated with collisions, as the transmission opportunity has previously been reserved for transmissions by the second wireless device. Additionally, the disclosed method of allocating a data communications medium for the first wireless device's transmission may be relatively efficient compared to other methods as described above. For example, the request by the first wireless device for a reverse direction grant may in some embodiments be embedded in an existing control frame exchange between the first and second wireless devices. Thus, the first wireless device may be able to obtain permission to transmit during a transmission opportunity of the second wireless device without transmitting any additional messages on the wireless network.

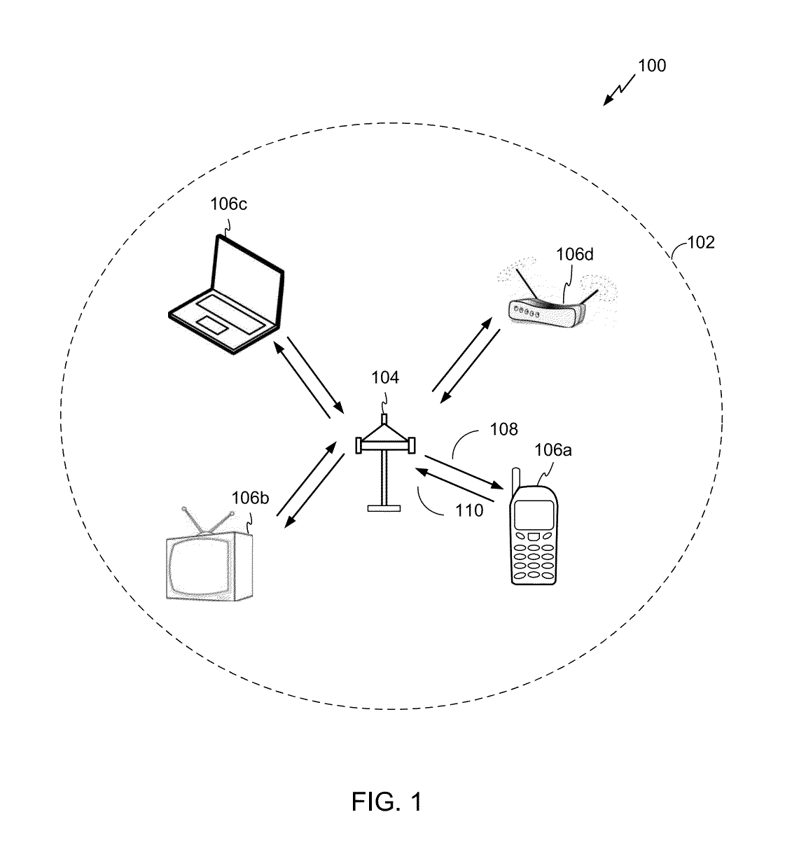

FIG. 1 shows an exemplary wireless communication system 100. The wireless communication system 100 may operate pursuant to a wireless standard, for example the 802.11 standards. The wireless communication system 100 may include an AP 104, which communicates with STAs 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

The AP 104 may transmit a beacon signal (or simply a “beacon”), via a communication link such as the downlink 108, to other nodes STAs 106 of the system 100, which may help the other nodes STAs 106 to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information both common (e.g. shared) amongst several devices, and information specific to a given device.

In some aspects, a STA 106 may be required to associate with the AP 104 in order to send communications to and/or receive communications from the AP 104. In one aspect, information for associating is included in a beacon broadcast by the AP 104. To receive such a beacon, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the AP 104. In some aspects, the AP 104 may use backhaul services, for example, to communicate with a larger network, such as the Internet or a public switched telephone network (PSTN).

During transmission of downlink data from an AP 104 to a STA 106, data may be transmitted from the AP 104 to the STA 106 during a transmission opportunity of the access point. The AP 104 may indicate in one or more data transmissions to the STA 106 that it is granting the STA 104 a reverse direction grant. This reverse direction grant is not provided in response to a request by the STA 104, but instead is provided independently by the AP 104 to allow the STA 104 to send an acknowledgement message for one or more data messages sent to the STA 104 by the AP 104 during the transmission opportunity of the AP 104. By allowing acknowledgement messages to be sent during the transmission opportunity of the AP 104, downlink data may be sent by the AP 104 during the transmission opportunity without providing a separate transmission opportunity to the STA 106 to acknowledge the data. This may improve throughput and data communication medium utilization.

Proposed herein is a feature of a first wireless device to request permission to transmit data during a transmission opportunity of a second wireless device. In some embodiments, the first wireless device may be the STA 106 discussed above. In some embodiments, the second wireless device may be AP 104 discussed above. This may improve transmission media utilization and reduce the amount of time a STA 106 in inhibited from entering a sleep state.

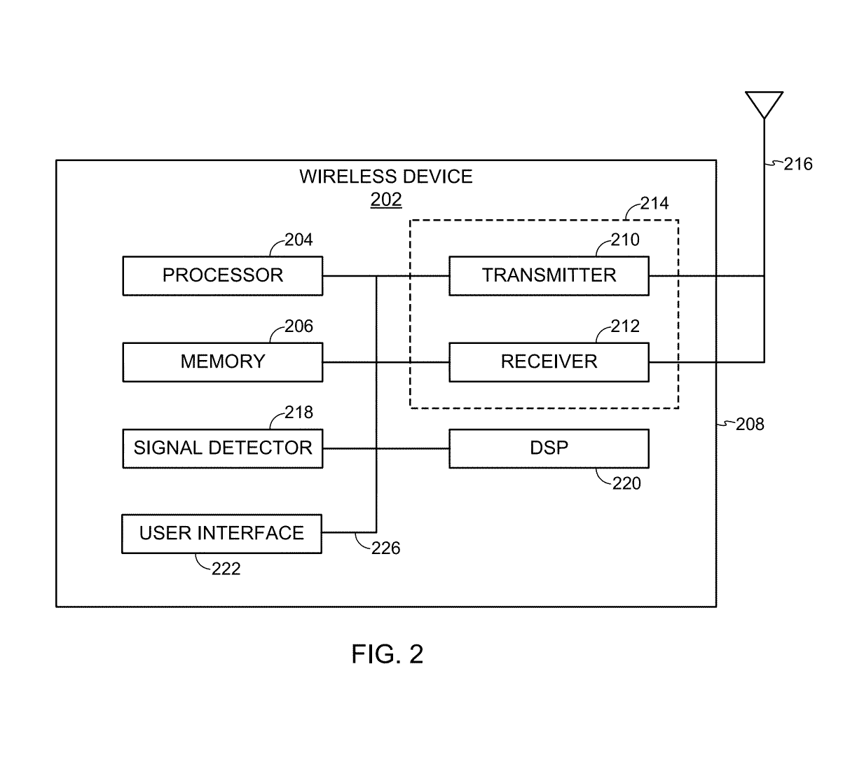

FIG. 2 shows an exemplary functional block diagram of a wireless device 202 that may be employed within the wireless communication system 100 of FIG. 1. The wireless device 202 is an example of a device that may be configured to implement the various methods described herein. For example, the wireless device 202 may comprise the AP 104, or one of the STAs 106. The wireless device 202 may comprise a first wireless device or a second wireless device.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

The wireless device 202 may comprise an AP 104, or a STA 106, and may be used to transmit and/or receive communications. That is, either AP 104, or STA 106, may serve as transmitter or receiver devices. Certain aspects contemplate signal detector 218 being used by software running on memory 206 and processor 204 to detect the presence of a transmitter or receiver.

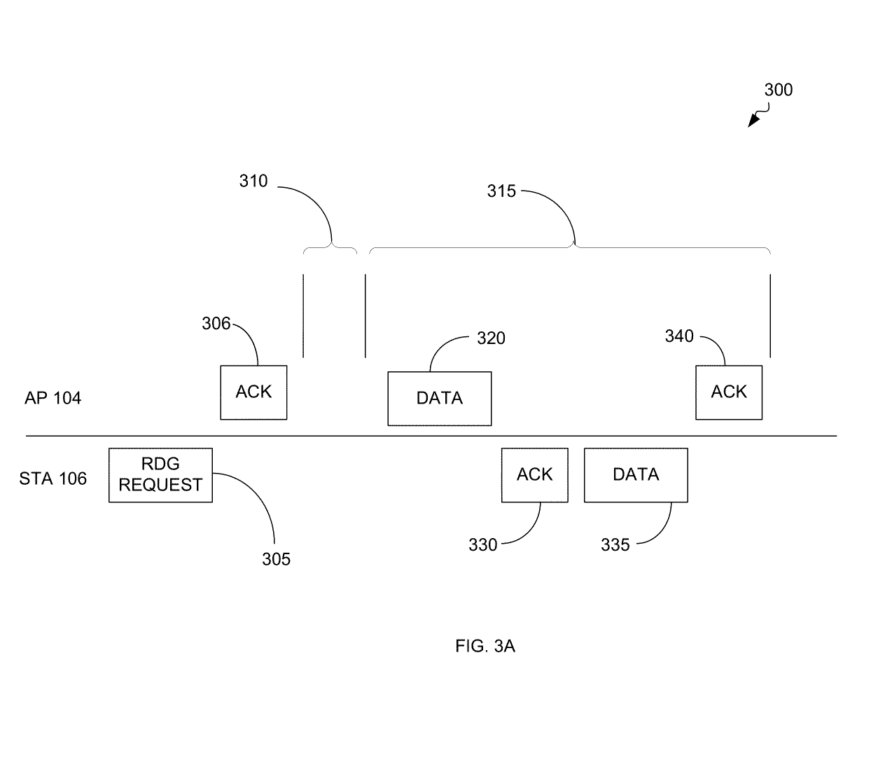

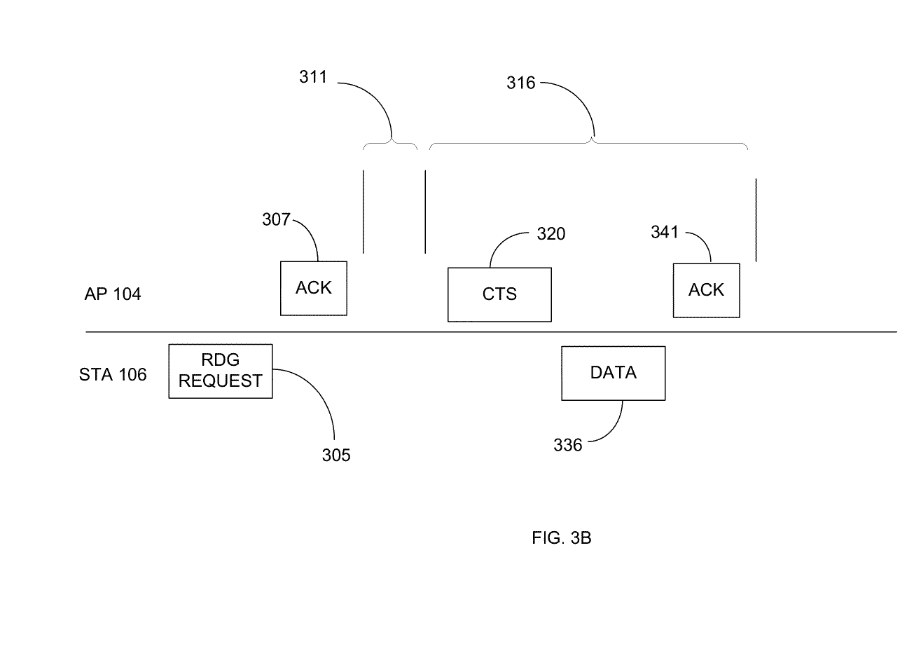

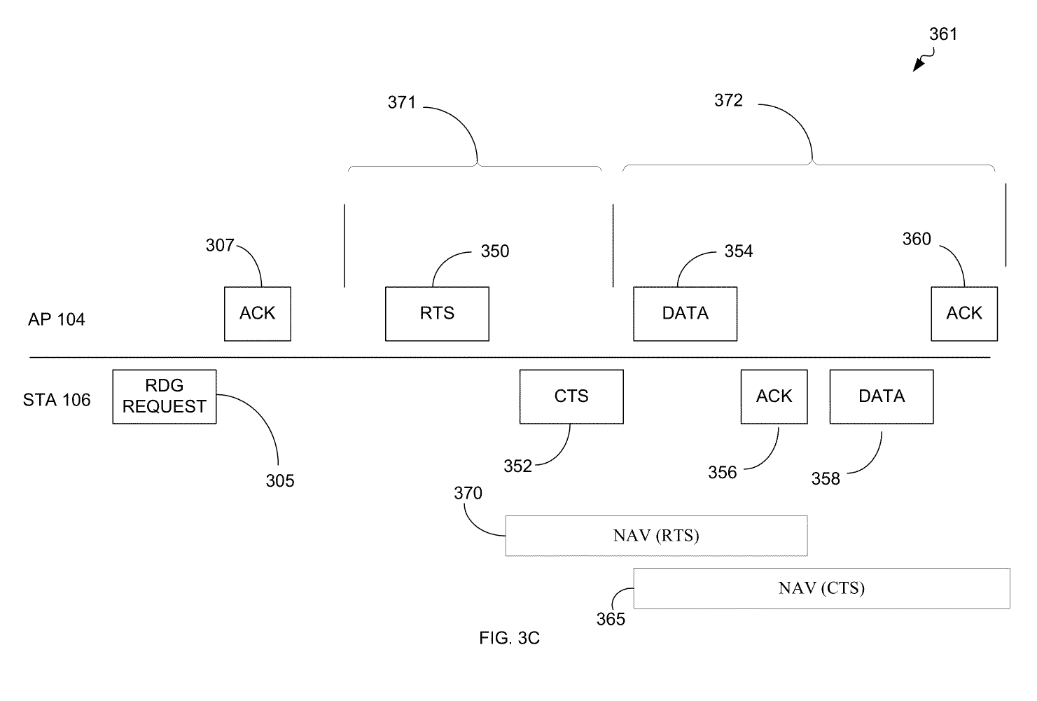

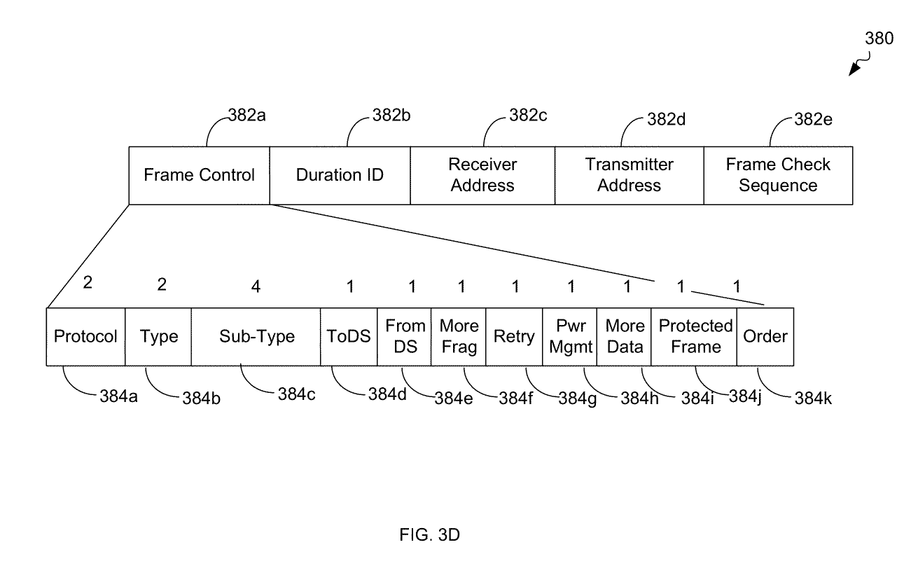

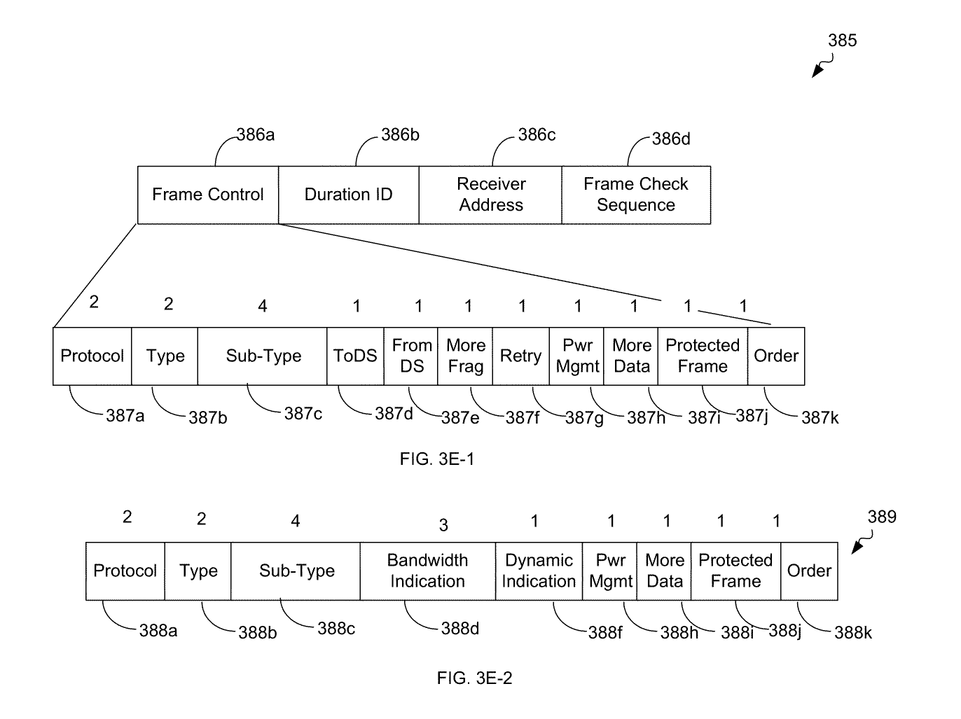

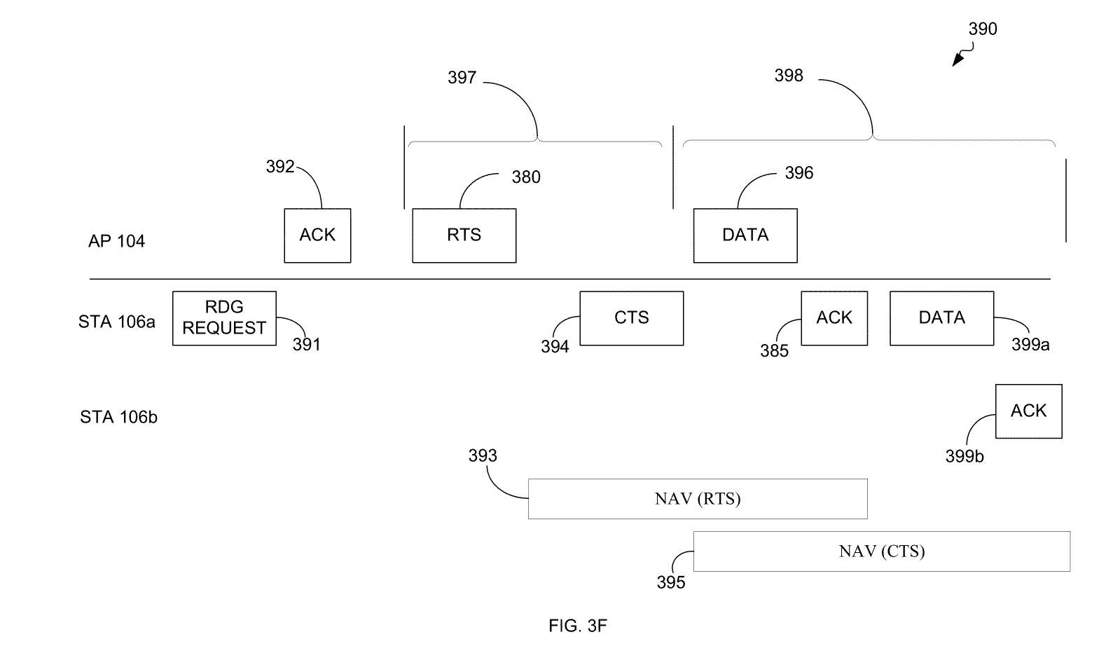

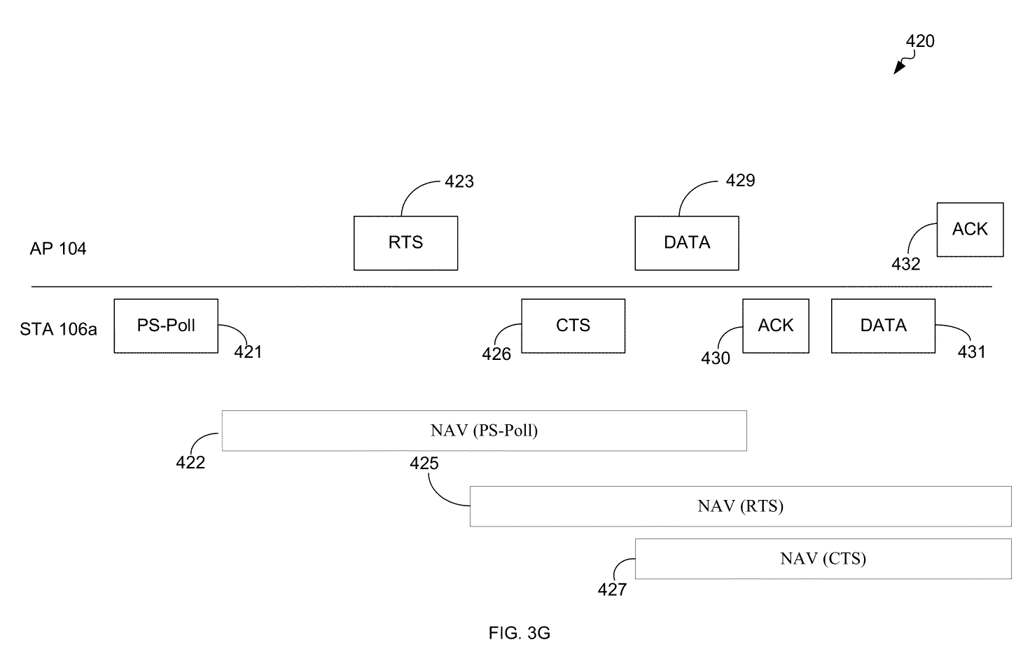

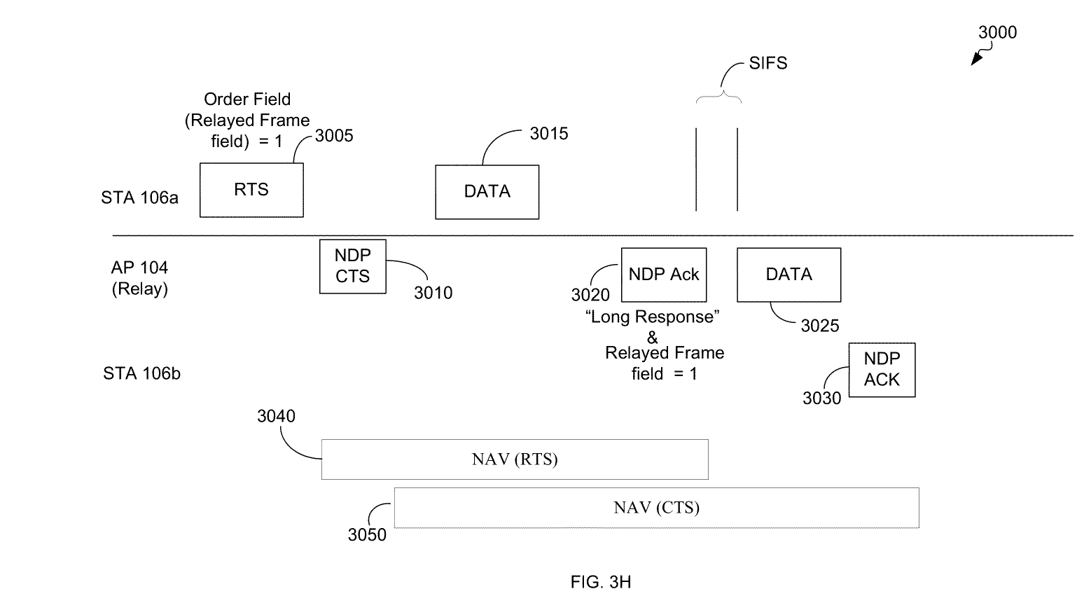

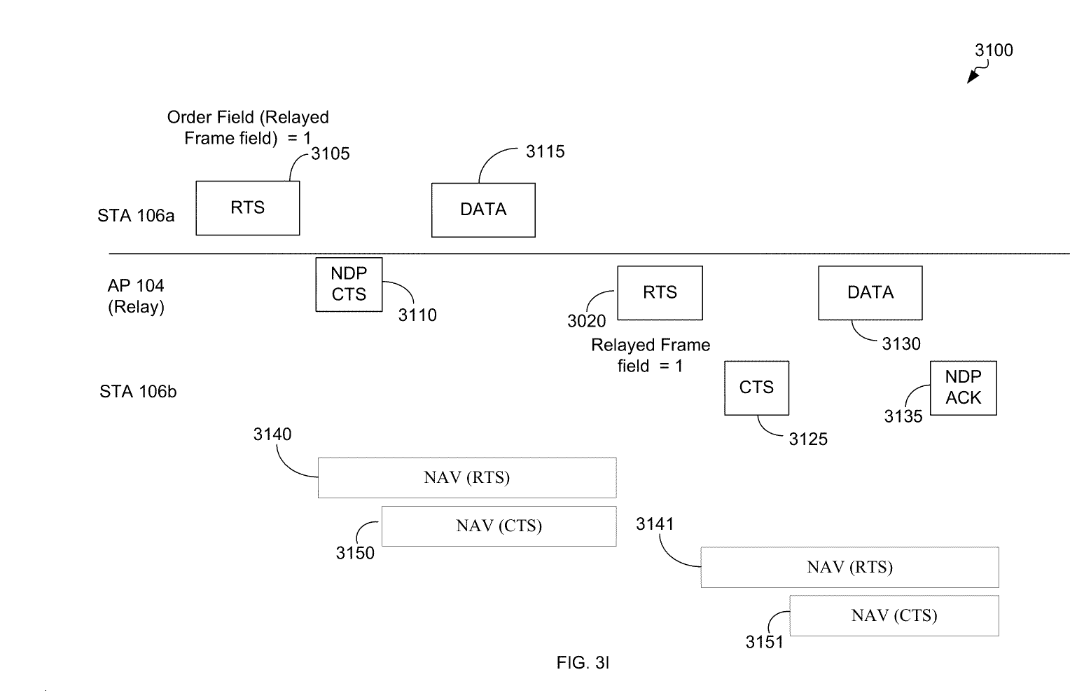

FIG. 3A is a timing diagram of one embodiment of a message exchange allocating a data communications medium between an access point and a station. In some aspects, the messages exchanged in FIG. 3A may be preceded by a negotiation between the AP and the STA defining whether a reverse direction grant request transmitted by the STA is supported. The timing diagram starts at the left with a station (STA) sending a reverse direction grant request message 305 to the access point. The reverse direction grant request message requests permission for the station to transmit data during a transmission opportunity of a second wireless device. In an embodiment, the message 305 may be a “ps-poll” message or any trigger frame. In an embodiment, the request message 305 includes an indication of a duration of time for which permission to transmit is sought by the station. For example, in an embodiment, the station may determine an amount of data available to transmit. The station may then determine a duration of time required to transmit the amount of data. In one aspect, the duration may be indicated in an uplink data indication (UDI) field of a ps-poll message. The station may then specify the duration in the request 305. In an embodiment, the station may include in the request 305 the amount of data available to transmit and the intended MCS to be used for transmitting the data. In another embodiment the devices may implicitly agree (for example during association) to reserve the remaining portion of their TXOP to each other. In some aspects, the devices may exchange management frames to negotiate whether a remaining portion of a TXOP may be granted to one device by another. In some aspects, this negotiation may be performed via the exchange of management frames. Similarly, a duration value may also be negotiated beforehand or the access point may allocate the maximum TXOP for each transmission opportunity.

The access point then transmits an acknowledgement message 306 to the station acknowledging the RDG request message 305. The acknowledgement message 306 may include an indication that permission to transmit during a transmit opportunity of the access point is granted. In an embodiment, the acknowledgment message 306 may also include a duration field, indicating a period of time for which the station has permission to transmit during a transmission opportunity of the access point. In an embodiment, the acknowledgement message 306 may include a delay field, indicating a period of time after which the access point expects the station to be able to transmit during the transmission opportunity of the access point. In an embodiment, the delay field may indicate a duration of time after which the access point will initiate packet exchange with the station. In an embodiment, the station may sleep for a time period based on the delay after receiving the acknowledgement message 306.

In an embodiment, the ACK message 306 may include a reverse direction MCS field which may be used by the station for rate adaptation purposes. The reverse direction MCS can be calculated with any method based on the SNR of the received RDG request message 305 or any other rate adaptation metric. In addition the access point may use the reverse direction MCS field to correctly calculate the Network Allocation Vector (NAV) to be allocated for reverse direction data. In one embodiment the delay field may have a zero (0) value indicating that the data exchange may begin at a SIFS time after the ACK is sent.

In the illustrated embodiment, the acknowledgement message 306 may include a “more data” indication that is set, indicating that the station should expect data to be transmitted from the AP 104 to the station 106 before the STA 106 can transmit during an AP 104 transmission opportunity. In an embodiment (not shown), the acknowledgement 306 may include an indication that the requested reverse direction grant was not granted. In this embodiment, the acknowledgement 306 may also include a sleep field (which may be the same delay field discussed above), indicating an amount of time the station may sleep before receiving data from the access point. In this embodiment, the station may sleep for a time period based on the sleep field. After the station wakes from the sleep period, it may send a ps-poll message to the access point. In an embodiment, no ps-poll message will be sent in response to the station waking up, but the station may instead wait for data to be transmitted to the station by the access point.

In the illustrated embodiment, the wireless medium then enters a contention period 310. After the contention period 310, a transmission opportunity of the access point 315 begins. During the transmission opportunity of the access point 315, the access point 104 transmits data 320 to the station 106. In an embodiment, AP 104 transmitting data 320 to the STA 106 is consistent with a “more data” indication in the acknowledgement message 306 discussed above. The data 320 may include an indication that the station is granted permission to transmit during the transmission opportunity of the access point 315. For example, a bit in a packet header (e.g., RDG/More PPDU bit) of the data may be reserved for the indication. When the bit is set, it may indicate permission is granted. The station responds to the data 320 with an acknowledgement packet 330. In another embodiment the station may immediately respond with its own data using the reverse direction grant and may piggyback the acknowledgement with the data. In other embodiments different types of reverse direction grant protocols may be used.

While the access point is shown transmitting a data packet 320 at the start of the transmission opportunity 315, in some embodiments, the access point may have no data to send. This indication may be consistent with the more data indication in the ack message. An example of this is shown in FIG. 3B below.

After transmitting the acknowledgment packet 330, the station transmits data 335 during the transmission opportunity of the access point 315. The data 335 may include one or more separate data packets. In an embodiment, the data 335 may be addressed to the access point (shown). In an embodiment, the data may be addressed to a node other than the access point (not shown). In an embodiment (not shown), the data may also be broadcast or multi-cast. In one embodiment the data 335 may be sent using a preferred MCS indicated by the access point in the acknowledgement message. In the illustrated embodiment, after the data 335 is transmitted by the station, the access point 104 responds with an acknowledgement packet 340. In an embodiment, the access point may transmit a CF-END frame (not shown) to end the transmission opportunity 315 after the STA 106 transmits the data 335.

Note that while FIG. 3A shows the AP 104 transmitting a set of messages and the STA 106 transmitting a set of messages, one with skill in the art would recognize that in other embodiments, any type of node could transmit either set of messages.

FIG. 3B is a timing diagram of one embodiment of a message exchange allocating a data communications medium between an access point and a station. In some aspects, the messages exchanged in FIG. 3B may be preceded by a negotiation between the AP and the STA defining whether a reverse direction grant request transmitted by the STA is supported. In some aspects, this negotiation may be performed via the exchange of management frames. The timing diagram starts at the left with a station (STA) 106 sending a reverse direction grant request message 305 to the access point. The reverse direction grant request message requests permission for the station to transmit data during a transmission opportunity of a second wireless device.

The access point then transmits an acknowledgement message 307 to the station acknowledging the RDG request message 305. The acknowledgement message 307 may include an indication that permission to transmit during a transmission opportunity of the access point is granted. In an embodiment, the acknowledgment message 307 may also include a duration field, indicating a period of time for which the station has permission to transmit during a transmission opportunity of the access point. In an embodiment, the acknowledgement message 307 may include a delay field, indicating a period of time after which the access point expects the station to be able to transmit during the transmission opportunity of the access point. In an embodiment, the station may sleep for a time period based on the delay after receiving the acknowledgement message 307.

In an embodiment, the acknowledgement message 307 may include a “more data” indication that is clear (“more data”=0). If permission to transmit during a second wireless device transmission opportunity is granted by the acknowledgement message 307, a clear “more data” indication may indicate the STA 106 will receive a trigger frame from the AP 104 when it is allowed to transmit during an AP transmission opportunity.

The wireless medium then enters a contention period 311. After the contention period 310, a transmission opportunity of the access point 316 begins. During the transmission opportunity of the access point 316, the access point 104 transmits a trigger frame 320 to the station 106. In the illustrated embodiment, the trigger frame is a clear-to-send message. Alternatively, the access point 104 may send a QOS Null message to the station 106 as a trigger frame. In general the trigger frame can be any control, management or data frame.

Transmission of the trigger frame at the start of the transmission opportunity 316 is consistent with the “more data” indication being clear in the acknowledgement message 307. The trigger frame 320 may include an indication that permission for the STA 106 to transmit during the transmission opportunity 316 is granted. In another embodiment, the two peer wireless devices may implicitly agree to grant a RDG to each other during association or with periodic management frames (e.g. beacons). An implicit agreement may provide the same or similar functions as the trigger frame 320.

In some aspects, the two peer wireless devices may exchange management frames to define a periodic reverse direction grant of the TXOP of one device to the other device. In some aspects, this exchange of management frames may further define a duration of time of the periodic reverse direction grant or a duration of time between each reverse direction grant. In this aspect, an access point may transmit a reverse direction grant indication periodically at the agreed to times. A station may schedule itself to wake-up so as to receive the reverse direction grant from the access point and transmit uplink frames after the reverse direction grant is received as described further below.

The station then transmits data 336 during the transmission opportunity of the access point 316. The data 336 may include one or more separate data packets. In an embodiment, the data 336 may be addressed to the access point (shown). In an embodiment, the data may be addressed to a node other than the access point (not shown). In an embodiment (not shown), the data may also be broadcast or multi-cast. In the illustrated embodiment, after the data 336 is transmitted by the station, the access point 104 responds with an acknowledgement packet 341. In an embodiment, the access point may transmit a CF-END frame (not shown) to end the transmission opportunity 316 after the STA 106 transmits the data 336. In another embodiment, the CF-END may also be sent if the STA is unresponsive for a time that exceeds SIFS time (+1 slot).

While FIG. 3B illustrates an access point 104 transmitting a first set of messages and station 106 transmitting a second set of messages, one with skill in the art would recognize that either an access point or a station could transmit either the first set and/or the second set of messages.

In one embodiment the ‘more data’ bit can be utilized by the access point (or in general the second wireless device) to indicate that a reverse direction grant will be granted. In such an embodiment, the AP (or in general the second wireless device) may set the more data bit in response to receiving a reverse direction grant request, such as request 305 (which may be a ps-poll or a trigger frame in one aspect). For example, the acknowledgement message 307 may have its more data bit set to 1. The AP may set the more data bit even if it has no downlink data buffered for the STA as shown in FIG. 3B. In this embodiment, instead of sending the downlink buffered units after the contention period 311, the AP can send a downlink frame (CF-Poll, Qos Null, CTS-to-Self, etc) which has the purpose of granting the remaining portion of the TXOP (or NAV) to the STA (or in general the first wireless device). The downlink frame may be sent after a time period based on a sleep duration field. The downlink frame initiates a packet exchange with the STA and sets the NAV to protect the STA's uplink transmission. In this embodiment, the downlink frame 320 is the initiator of the reverse direction grant.

In some aspects, the STA may not have any uplink data buffered to be transmitted to the access point. For example, this may occur when uplink data reaches its maximum lifetime. Alternatively, multiple scheduled reverse direction grants may be established between the AP and the STA, such that the STA may not always have enough data to fill each (potentially periodic) reverse direction grant from the access point. In some of these aspects, the STA may transmit a null data frame to indicate that it has no additional data to send. In response to receiving the null data frame, the access point may transmit one or more wireless messages to cancel any remaining reverse direction grant transmission opportunity to the station.

In other aspects, when the STA has no data available to transmit during a granted TXOP, the STA may not transmit any data during the granted TXOP. In response to not receiving any data from the STA, the AP may reset the NAV (or in other terms, free the TXOP) by transmitting a “CF-END” frame or alternatively a clear-to-send message to itself with a duration field set to zero. This can include a null data packet (NDP), clear-to-send, or clear to send to self. In some aspects, these messages include a bit indicating to receiving devices that they should reset their NAV (instead of setting the NAV).

In one aspects, a null data packet CTS may reset the NAV by including in a duration field a value equal to a NAV set by other STAs. In this aspect, a STA may transmit an NDP CTS (to self). This may set the NAV to all the STAs that successfully receive the NDP CTS) with a duration field set to a value indicating that the NAV lasts up to an indicated time T. Next, the same STA may transmit another NDP CTS (to self) to reset the NAV for all the STAs that successfully receive the second NDP CTS) by setting the duration field to a second value indicating a time interval up to the time T plus or minus a permitted delta to allow for errors.

A reverse direction grant may utilize any method that provides an implicit or explicit indication that the STA can transmit any type of frame SIFS time after receiving the downlink frame by the AP. Note that the method is applicable to any devices, not only between an AP and STA.

FIG. 3C is a timing diagram of one embodiment of a message exchange 361 allocating a data communications medium between an access point and a station. In some aspects, the messages exchanged in FIG. 3C may be preceded by a negotiation between the AP and the STA defining whether a reverse direction grant request transmitted by the STA is supported. In some aspects, this negotiation may be performed via the exchange of management frames. The timing diagram starts at the left with a station (STA) sending a reverse direction grant request message 305 to the access point. The RDG request message 305 is acknowledged by acknowledgement message 307. After the acknowledgement message is transmitted, the wireless medium enters a contention period 371. During the contention period, the access point may transmit a request to send message 350. The request to send message 350 may indicate a NAV period 370 for transmission of data by the AP 104.

In response, the station may transmit a clear-to-send message 352. In an embodiment, the clear-to-send message 352 may indicate a NAV period 365 that additionally indicates the period of time necessary for the station to send data it intends to send during a remaining portion of the NAV period, i.e., the NAV duration is extended to include the time necessary for the station to send its data. In another embodiment, the CTS frame may set a “more data” bit to indicate that it has data for the access point. After the clear-to-send message 352 is transmitted by the STA 106, the wireless medium enters a contention free period 372. The contention free period 372 may be based, at least in part, on the NAV period 365 indicated by the CTS message 352 transmitted by the station.

This contention free period 372 may correspond to a transmission opportunity of the access point 104. The AP 104 may then transmit data packet 354. The data packet 354 may also include a duration field consistent with the duration of the NAV 365 established by the CTS frame 352. In some aspects, the AP 104 may precede transmission of the data packet 396 with a CTS frame (not shown) indicating the updated NAV 395. For example, some aspects of data packet 396 may not include a duration field, and therefore it may be useful to first transmit a CTS frame with a duration field indicating the updated NAV. This may ensure that a device on the wireless network that is receiving transmissions of the AP 104 but not of the STA 106 recognizes the updated NAV value provided by the CTS frame 352.

In the illustrated aspect, the data packet 354 is then acknowledged by the STA 106 with ACK message 356. STA 106 may then send data packet 358 to the access point during the transmission opportunity of the access point. Note that data packet 358 is sent during the contention free period 372 that was extended relative to the NAV period 370 indicated by the request-to-send message 350. The data message 358 is then acknowledged by the AP 104 with ACK message 360. Thus, FIG. 3A shows that an RTS/CTS exchange between the AP 104 and STA 106 may extend the non-contention period of the wireless medium, for example, by indicating a NAV period, to ensure adequate time to transmit data by both the AP and the STA 106.

In an embodiment, the AP 104 may deny the extension of the contention free period request by the station in the clear-to-send message 352. For example, the AP 104 may ignore an updated NAV indicated in the clear-to-send message 352 and transmit a NAV value that was in effect prior to the transmission of the CTS message 352. In an embodiment, the AP 104 may deny the extension of the contention free period by clearing a RDG/More PPDU bit in a packet transmitted after the CTS message 352 is received.

In a further embodiment, request-to-send message 350 may not be transmitted by the AP 104, but the clear-to-send message 352 may still be transmitted by the STA 106. In this embodiment, the clear-to-send message 352 may still indicate an indication of an increased NAV value as described above.

In this embodiment, after the CTS message is transmitted, the AP 104 may transmit a packet or message indicating the remaining NAV time period may be used by the station. This indication may be a reverse direction grant bit (RDG/more PPDU bit), or an implicit indication which can be performed by having the access point setting a larger NAV for its communications with the RTS and granting part of the NAV with the data packet.

In another embodiment, a request-to-send and clear-to-send exchange may occur without a preceding ps-poll/acknowledgement sequence. In this embodiment, a station that replies to a request-to-send with a clear-to-send message may include an indication in the clear-to-send message that extends the NAV time period to ensure enough time for the station to send data during a remaining transmission opportunity using the reverse direction protocol. In an embodiment, the indication in the clear-to-send message may extend the NAV period by using a more data bit. In an embodiment, other bits in the frame control portion of the clear-to-send message may be overloaded to provide the indication.

Table 1 below summarizes one embodiments use of indications in request and response messages transmitted on a wireless medium

| RDG | RDG | More | Sleep | | |
|---|---|---|---|---|---|
| Req | Resp | Data | Duration | AP Behavior | STA Behavior |
| 1 | 0 | 1 | S | Transmit | ACK Reception of |
| | | | | downlink data | downlink data, do |
| | | | | SIFS (S) time | not transmit uplink |
| | | | | after | data during |
| | | | | acknowledgement | transmit |
| | | | | | opportunity |
| 1 | 0 | 0 | 0 | AP has no data to | Do not transmit |
| | | | | transmit. Reverse | during AP |
| | | | | Direction Not | transmission |
| | | | | Granted | opportunity |
| 1 | 1 | 1 | 0 | Transmit | Acknowledge |
| | | | | downlink data | reception of |
| | | | | SIFS time after | downlink data, use |
| | | | | ack, Reverse | reverse direction |
| | | | | Direction granted | grant for uplink |
| | | | | to station. | transmission. |
| 1 | 1 | 0 | 0 | No data to | Transmit uplink |
| | | | | transmit, reverse | data SIFS time |
| | | | | direction not | after |
| | | | | granted to station | acknowledgement. |
| 1 | 0 | 0 | S | No data to | Sleep for S ms, do |
| | | | | transmit, no | not transmit uplink |
| | | | | reverse direction | data during AP |
| | | | | granted. | transmit |
| | | | | | opportunity |
| 1 | 1 | 1 | S | Transmit | Transmit |
| | | | | downlink data S | acknowledgement |
| | | | | ms after | of received |
| | | | | acknowledgement, | downlink data, use |
| | | | | reverse direction | remaining portion |
| | | | | granted to station. | of transmit |
| | | | | | opportunity for |
| | | | | | uplink |
| | | | | | transmission. |
| 1 | 1 | 0 | S | No data to | Utilize reverse |
| | | | | transmit, reverse | direction grant |
| | | | | direction granted | indicated by |
| | | | | to station. Access | trigger frame for |
| | | | | point may | uplink |
| | | | | transmit a trigger | transmission. |
| | | | | frame after S | |
| | | | | duration of time | |

FIG. 3D shows a format of an exemplary request-to-send (RTS) frame 380. The RTS frame 380 may be transmitted as part of some aspects of communication exchange 361 of FIG. 3C. For example RTS 350 shown in communication exchange 361 may conform to the format of RTS frame 380.

The RTS frame 380 includes a frame control field 382a, as well as a duration/id field 382b, receiver address field 382c, transmitter address field 382d and frame check sequence (FCS) field 382e. The frame control field 382a may be composed of multiple fields, including a protocol field 384a, type field 384b, sub-type field 384c, toDS field 384d, fromDS field 384e, More Frag field 384f, Retry field 384g, Pwr Mgmt field 384h, More Data field 384i, Protected Frame field 384j, and Order field 384k.

In some aspects, the RTS frame 380 may indicate whether a receiving device has permission to extend a reverse direction grant NAV duration indicated by the duration/ID field 382b (as was shown by the transmission of CTS frame 352 in FIG. 3C, which extended the NAV from a duration indicated by NAV 370 to a duration indicated by NAV 365). In some aspects, the order field 384k may be set to one to indicate that the transmitter of the RTS frame 380 allows a receiver of the RTS frame (for example, the TXOP responder) to extend the NAV and transmit during the extended portion of the NAV as illustrated in FIG. 3C. In some other aspects, other fields of the RTS frame may be used to indicate whether permission is granted. (e.g., Retry bit, Protected frame field in the Frame Control field of the RTS). For example, other reserved fields or bits within the RTS frame 380 may be used to indicate whether permission to extend the NAV is granted. In one embodiment the permission to extend the NAV may be for the sole purpose of relaying a frame to a third device by the TXOP Responder. In some aspects, the order field 384k may be a relayed frame field in an 802.11ah standard.

In other aspects, whether permission to extend the NAV is granted to a TXOP responder may be communicated through the exchange of management frames that occurs before the RTS message (such as RTS message 350) is transmitted.

FIG. 3E-1 shows a format of an exemplary acknowledgment frame 385. The acknowledgment frame 385 includes a frame control field 386a, duration/id field 386b receiver address field 386c, and a frame check sequence field 386d. Similar to FIG. 3D, the frame control field 386a includes a protocol field 387a, type field 387b, sub-type field 387c, toDS field 387d, fromDS field 387e, More Frag field 387f, Retry field 387g, Pwr Mgmt field 387h, More Data field 387i, Protected Frame field 387j, and Order field 387k. In some aspects, the more data field 387i may be used to indicate that a transmitting device will utilize a remaining portion of a transmission opportunity as a TXOP requestor to transmit data to a device other than the TXOP owner. Such an embodiment is shown in FIG. 3F below.

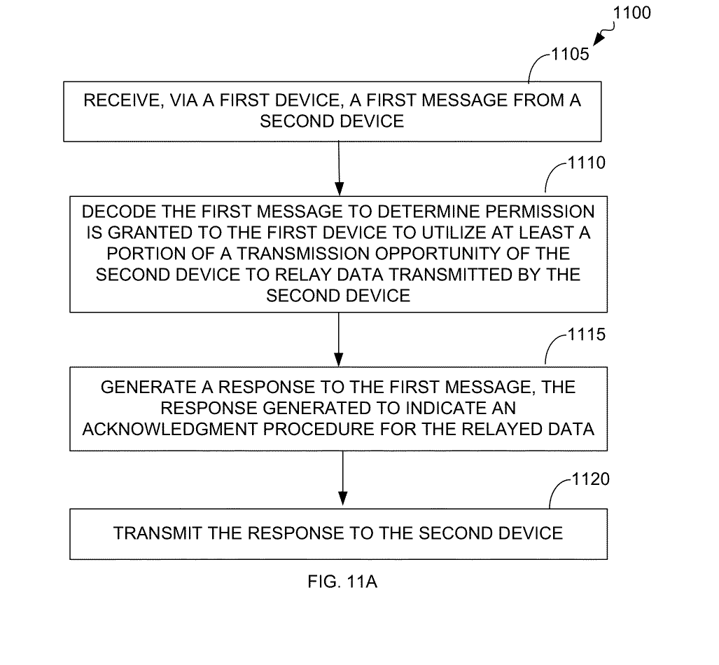

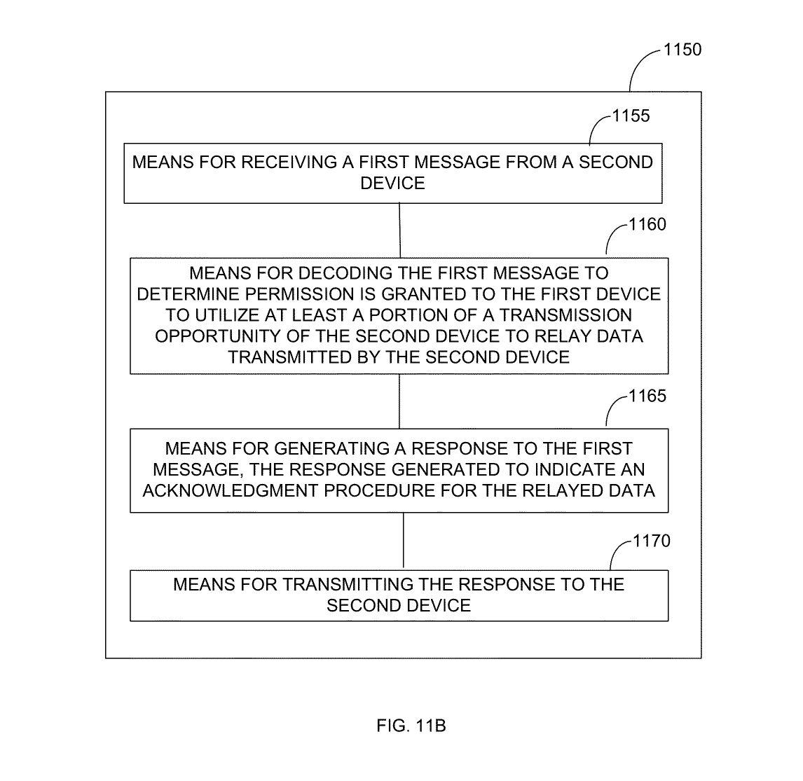

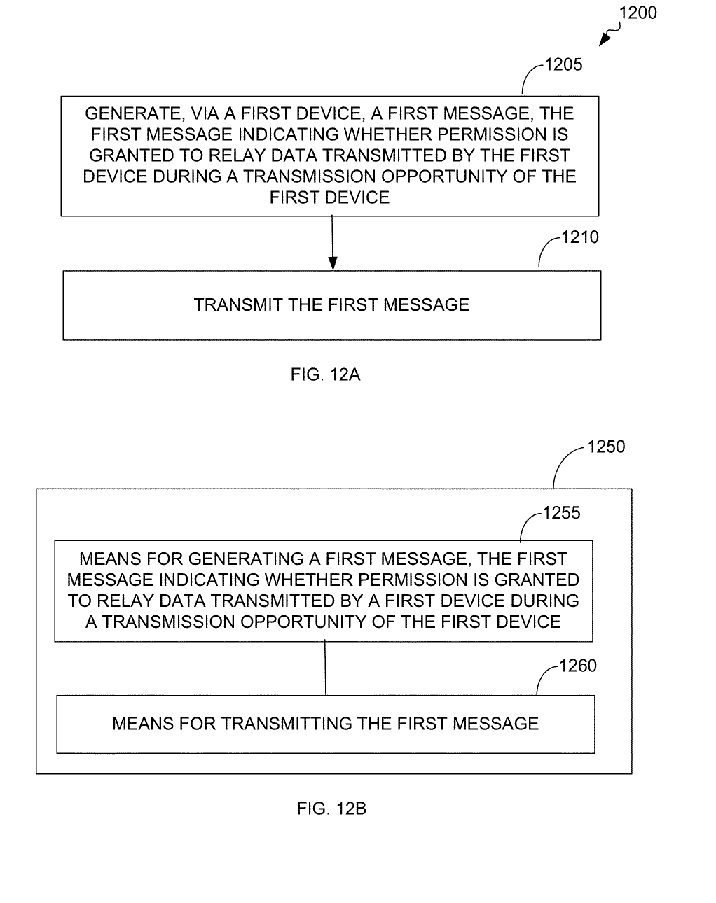

In some embodiments, the acknowledgment may be a null data packet acknowledgement (NDP ACK) frame. A NDP acknowledgment frame (not shown) includes an NDP Type field, ACK ID field, Duration field, More Data field a Relayed Frame, and a CRC field. In such an embodiment the device transmitting the NDP Ack as a response to a received data frame from the TXOP holder, may indicate that it will use the remaining portion of the TXOP to transmit data to a device other than the TXOP owner. In one embodiment this may be indicated by having the relayed frame field of the NDP ACK set to 1. In some aspects, a TXOP owner may indicate permission for a second device to relay data during the TXOP by using the order field 387k, as discussed below with respect to FIGS. 3H-I and FIGS. 11A-12B.

FIG. 3E-2 shows an alternative format of the frame control field 386a of FIG. 3E-1. The frame control field format 389 of FIG. 3E-2 includes a protocol field 388a, type field 388b, sub-type field 388c, bandwidth indication field 388d, dynamic indication field 388f, Pwr Mgmt field 388h, More Data field 388i, Protected Frame field 388j, and Order field 388k. In some aspects, the more data field 388i may be used to indicate that a transmitting device will utilize a remaining portion of a transmission opportunity as a TXOP requestor to transmit data to a device other than the TXOP owner. In some aspects, a TXOP owner may indicate permission for a second device to relay data during the TXOP by using the order field 388k, as discussed below with respect to FIGS. 3H-I and FIGS. 11A-12B.

FIG. 3F is a timing diagram of one embodiment of a message exchange 390 allocating a data communications medium between an access point and a station. While FIG. 3F illustrates an AP 104 as a TXOP owner and an STA 106a as a TXOP responder, one of skill in the art would recognize that in some aspects, an AP 104 may be a TXOP responder and a STA may be a TXOP owner. Alternatively, in other aspects, both the TXOP owner and TXOP responders may be stations (that may perform relay functionality).

Similar to message exchange 361 of FIG. 3C, message exchange 390 illustrates a station 106a transmitting an RDG request message 391 to an AP 104. The AP acknowledges the RDG Request message 391 with acknowledgement message 392. The communications network illustrated in FIG. 3F then enters a contention period 397. The AP 104 then transmits an RTS message 380. A duration field in the RTS message 380 indicates a duration or NAV as shown by NAV 393. This RTS message 380 may indicate whether a receiving device, such as STA 106a, has permission to extend the NAV duration indicated by the RTS message 380 (as discussed above with respect to FIG. 3D). In the illustrated communication exchange, the RTS message 380 indicates the STA 106a does have permission to extend the NAV. STA 106a responds with a CTS 394, which extends the NAV to a duration indicated by NAV 395. The communications network of FIG. 3F then enters a non-contention period 398.

The AP 104 then transmits data frame 396 to the STA 106a. The data frame 396 may include a duration field indicating a NAV consistent with the updated NAV 395 indicated by the CTS frame 394. In some aspects, the AP 104 may precede transmission of the data packet 396 with a CTS frame (not shown) indicating the updated NAV 395. In one embodiment, the CTS frame in general may be a null data packet CTS (NDP CTS) (not shown).

In the illustrated embodiment, STA 106a acknowledges data frame 396 with acknowledgment packet 385. As discussed above with respect to FIG. 3E-1, the acknowledgment packet 385 may indicate whether the STA 106a intends to transmit a frame to a 3^{rd} device during the transmission opportunity 398. In the illustrated example of FIG. 3F, the acknowledgment packet 385 does indicate that the STA 106a will transmit data to a 3^{rd} device during the transmission opportunity 398 of the AP 104. For example, the STA 106a may indicate this via acknowledgment packet 385 by setting the more data field 387i. In another embodiment (not shown) where the acknowledgement packet is an NDP acknowledgement frame, the STA 106a may provide the indication by setting a Relayed Frame bit included in the NDP ACK frame.

STA 106a then transmits data packet 399a to the STA 106b. STA 106b acknowledges the data packet 399a with acknowledgement packet 399b during the transmission opportunity 398.

While FIG. 3F illustrates the STA 106a indicating to the AP 104 in an acknowledgement packet 385 that it will transmit during the AP's transmission opportunity to a 3^{rd} party device (namely, STA 106b), in some aspects, no indication is provided. In still other aspects, various other types of wireless message frames may be used to provide such an indication to a TXOP Owner such as AP 104. For example, any frame a TXOP responder transmits to a TXOP owner may be used in alternate embodiments. Additionally, while FIG. 3F shows the TXOP responder (STA 106a) transmitting an acknowledgment packet 385 before transmitting data to the 3^{rd} party device (STA 106b), in some aspects, the TXOP responder may transmit data to a 3^{rd} party device SIFS time after a last frame is received from the TXOP owner by the TXOP responder. For example, in a variation of FIG. 3F, the STA 106a may transmit the data frame 399a before the acknowledgement frame 385 in some aspects.

FIG. 3G is a timing diagram of one embodiment of a message exchange 420 allocating a data communications medium between an access point and a station. While FIG. 3G illustrates an AP 104 as a TXOP owner and an STA 106a as a TXOP responder, one of skill in the art would recognize that in some aspects, an AP 104 may be a TXOP responder and a STA may be a TXOP owner. Alternatively, in other aspects, both the TXOP owner and TXOP responders may be stations (that may perform relay functionality).

FIG. 3G first shows the STA 106 transmitting a PS-Poll frame 421. The PS-Poll frame 421 includes a duration field. The value the STA 106 uses for the duration field may be based on the time for STA 106a to transmit one or more uplink data units to the AP 104 and/or an estimated time for the AP to transmit one or more downlink buffered units (BU's) to the STA 106a. In the example of FIG. 3G, a duration field in the PS-Poll frame 421 is set to the estimated time required for the STA 106a to transmit uplink data to the AP 104, plus SIFS time, plus any time necessary to receive an acknowledgement from the AP 104. This time is shown by NAV time period 422. In some aspects, the duration/ID field of the RTS message 423 (and corresponding length of the NAV time period 422) may be based equations (1) or (2) below:

D=T_{END-NAV}+T_{PENDING}−T_{PPDU}<=D<=T_{TXOP}_{_{—}}_{REMAINING}−T_{PPDU} (1)

D=T_{END-NAV}+T_{PENDING}−T_{PPDU}<=D (2)

where:
T_{SINGLE-MSDU} is the estimated time required for the transmission of the allowed frame exchange sequence defined in 8.4.2.28 (EDCA Parameter Set element) (for a TXOP limit value of 0), including applicable IFSs (#156).
T_{PENDING} is the estimated time required for the transmission of
   Pending MPDUs of the same AC
   Any associated immediate response frames
   Any NDP transmissions and explicit feedback response frames
   Applicable (#156) IFSs
   Any RDG
T_{TXOP} is the value of dot11EDCATableTXOPLimit (dot11EDCAQAP-TableTXOPLimit for the AP) for that AC.
T_{TXOP-REMAINING} is T_{TXOP} less the time already used time within the TXOP.
T_{END-NAV} is the remaining duration of any NAV set by the TXOP holder, or 0 if no NAV has been established.
T_{PPDU} is the time required for transmission of the current PPDU.

In one aspect, the PS-Poll frame 421 indicates whether the AP 104 is allowed to respond with an RTS via a Response Indication field in the S1G field of the Physical Layer Convergence Protocol (PLCP) Preamble. In some aspects, if this field is set to “Long Response,” the AP 104 is allowed to extend the NAV period 422 indicated in the PS-Poll frame 421 via a request to send. In these aspects, if the Response Indication field in the SIG field is set to another value other than “Long Response,” the AP cannot extend the NAV set by the PS-Poll frame 421.

Since the ps-poll frame 421 indicates the AP 104 is allowed to extend the NAV, upon reception of the PS-Poll frame 421 the AP 104 responds with a request-to-send (RTS) frame 423. The AP 104 may transmit the RTS frame 423 after determining that the AP 104 has buffered units available for the STA 106a. The RTS frame 423 may include a duration field equal to an amount of time indicated in the PS-Poll frame 421 plus any time needed for the AP to transmit downlink buffered units to the STA 106. The duration field in the RTS frame 423 may also include additional time necessary for the eventual times, SIFS, and any additional acknowledgements transmitted by the STA 106a. The NAV period requested by the RTS frame 423 is shown by NAV period 425. A “More Data” field in the RTS frame 423 may be equal to one (1), indicating that a NAV extension is requested to transmit the downlink buffered units to the STA 106a. Upon reception of the RTS frame 423, the STA responds, after SIFS time, with a (NDP) CTS frame 426. A duration field in the CTS frame 426 sets a NAV equal to the duration necessary to accommodate the NAV duration indicated by the RTS frame 423. The NAV period set by the CTS frame 426 is shown as NAV 427. Once the NAV period 427 is established, the AP 104 transmits downlink data 429. The STA 106a acknowledges the data 429 with acknowledgement 430, and then transmits uplink data 431. The AP then acknowledges uplink data 431 with acknowledgment 432.

FIG. 3H is a timing diagram of one embodiment of a message exchange 3000 allocating a data communications medium between a two stations 106a-b and an access point 104. While FIG. 3H illustrates the STA 106a as a TXOP owner and the AP 104 (relay) as a TXOP responder, one of skill in the art would recognize that in some aspects, a station 106 may be a TXOP responder and an AP may be a TXOP owner. Alternatively, in other aspects, both the TXOP owner and TXOP responders may be stations (that may perform relay functionality).

An S1G device that supports TXOP sharing may initiate a relay-shared TXOP by transmitting a S1G RTS frame with a relayed frame field (such as the order field 387k of FIG. 3E-1 or the order field 388k of FIG. 3E-2) set as a first frame in the exchange under Enhanced Distributed Channel Access (EDCA). A relay that receives the S1G RTS frame indicates whether it will utilize an explicit or implicit acknowledgment scheme during the relay-shared TXOP based in part by setting a response indication field in the S1G field of the PLCP Preamble or by setting the value of the Duration field of the response frame to a certain value as specified below. In certain embodiments the response frame is an NDP CTS frame. In some other aspects, the response frame is a CTS frame.

In some aspects, a relay can indicate explicit acknowledgments will be used by extending the NAV (relative to a NAV duration specified in the RTS frame) when transmitting the NDP CTS frame. When using implicit acknowledgement, a NDP CTS frame transmitted by the relay will not extend the NAV relative to that specified in the RTS frame.

In some other aspects, a non-NDP CTS frame will be transmitted in response to the RTS frame. This “regular” or non-NDP CTS may include a response indication field in its PLCP preamble that is set to “Long Response.” (Three (3) in some aspects) to indicate an explicit acknowledgment procedure will be used for relayed transmissions during the transmission opportunity.

If an explicit acknowledgement procedure will be utilized by the relay, the relay sets the duration field of the NDP CTS frame to a value D, where D is defined below:

D=min(T_{RTS}+T_{PENDING}−T_{PPDU};T_{TXOP}_{_{—}}_{REMAINING}−T_{PPDU})<=D<=T_{TXOP}_{_{—}}_{REMAINING}−T_{PPDU},

Where:
T_{RTS} is a value of the Duration/ID field of the S1G RTS frame that elicited the response,
T_{PPDU} is a time, in microseconds, between the end of the PPDU carrying the RTS frame and the end of the of the NDP CTS,
T_{PENDING} is an estimated time for the transmission of the frame to be forwarded and its response if required plus applicable IFS durations, and
T_{TXOP}_{_{—}}_{REMAINING} is equal to any T_{TXOP} minus T_{RTS}, where the TTXOP is the estimated amount of time of the current TXOP started by the TXOP initiator as known by the Relay.

FIG. 3H first shows the STA 106a initiating a relay-shared TXOP by transmitting an S1G request-to-send message 3005. In some aspects, instead of transmitting the request-to-send message 3005, a short data frame may be transmitted. The STA 106a indicates its intent to start a relay-shared TXOP by setting a relayed frame field in a frame control field of the RTS message 3005. In some aspects, the relayed frame field is the order field 387k of FIG. 3E-1 or order field 388k of FIG. 3E-2. The relay 3005 may also indicate an initial NAV duration of the TXOP shown by NAV 3040.

The AP 104 then responds with a null data packet (NDP) clear-to-send frame 3010. If the AP 104 intends to use an explicit acknowledgement procedure, in some aspects, the relay will set the duration field of the CTS frame 3010 to indicate a relay-shared TXOP protection mechanism. For example, the duration field of the CTS frame will be set as described above. The CTS frame 3010 may also extend the duration of the NAV to protect any expected future relay transmissions (such as forwarding the expected Data frame 3015 to the STA 106b plus receiving any acknowledgments etc). This is shown by NAV duration 3050. The STA 106a then transmits a data frame 3015.

After receiving the data frame 3015, and when using the explicit acknowledgement procedure, the relay AP 104 may set the NDP acknowledgment frame 3020 to have a response indication field in the S1G field of the PLCP Preamble to a value of “long response.” In addition, the relay may set the relayed frame field of the NDP acknowledgement frame 3020 to a first value (for example, one—shown). Otherwise, the relay shall signal a response indication of no response in the NDP acknowledgement frame 3020 by setting the relayed frame field to a second value (for example, “no response” or zero—not shown).

When using the explicit acknowledgment procedure, the relay 104 may forward the previously received short data frame 3015, SIFS time after the relay transmitted the NDP acknowledgement frame 3020 to the STA 106a. The relay 104 may further protect the forwarding of the data frame by preceding its transmission with an RTS/CTS exchange or by transmitting a CTS-to Self-frame with the STA 106b. Upon successful receipt of the relayed short data frame 3025, the STA 106b transmits an NDP acknowledgement frame 3030 to the relay 104. This description may apply to both uplink and downlink procedures with the STA 106a. For example, either the STA 106a or the AP 104 may be the TXOP owner in a TXOP sharing session.

FIG. 3I is a timing diagram of one embodiment of a message exchange 3100 allocating a data communications medium between a two stations 106a-b and an access point 104. FIG. 3I illustrates use of an implicit acknowledgement procedure with a relay-shared TXOP. While FIG. 3I illustrates the STA 106a as a TXOP owner and the AP 104 (relay) as a TXOP responder, one of skill in the art would recognize that in some aspects, a station 106 may be a TXOP responder and a AP may be a TXOP owner. Alternatively, in other aspects, both the TXOP owner and TXOP responders may be stations (that may perform relay functionality).

When an implicit acknowledgement procedure is utilized by a relay, it may set a response indication field of the S1G field of the PLCP Preamble in the response frame to an S1G RTS frame with the relayed frame set to 1 (e.g., the order field). to a value corresponding to “No response.” The response frame may be set in a CTS frame or a NDP CTS frame transmitted to the TXOP owner device. The duration/id field of the null data packet (NDP) clear-to-send (CTS) or CTS frame may be set to a value that is equal to the value of the Duration/ID field of the S1G RTS frame minus TPPDU as described above Upon successful reception by a relay of a short data frame 3115 from the TXOP owner, which is sent SIFS time after the transmission of the (NDP) CTS frame 3110 as described above, the relay may protect further transmission of the short data frame to a third device (to accomplish the relay) with a second RTS/CTS protection mechanism. A duration/ID field of a second RTS frame transmitted by the relay should be less than or equal to the maximum duration of a TXOP allocated for transmitting Short Data frames of the particular access category of Short Data frame 3115. This access category is available in a PTID field of a frame control field of frame 3115 minus an estimated time since the beginning of reception of the first RTS frame (which had the relayed frame set to a first value (e.g. one) and was transmitted by the relay-shared TOP owner. FIG. 3I illustrates this message sequence.

Similar to FIG. 3H, the message sequence using an implicit acknowledgement procedure also begins with a TXOP owner transmitting a S1G request-to-send (RTS) frame 3105 with the relayed frame set to 1 (e.g., the order bit set to 1) or Short data frame that includes a relayed frame field set to a first value (e.g. one). The RTS message 3105 indicates an initial NAV duration indicated by NAV 3140. Because 31 illustrates use of an implicit acknowledgement procedure, the NDP CTS frame 3110 does not extend the NAV 3140 set by the RTS, as shown by NAV 3150. The relay AP 104 responds with a null data packet (NDP) CTS frame 3110. A duration field of the CTS frame 3110 is set as described above to indicate implicit acknowledgments will be used.

Upon receiving the CTS 3110, the STA 106a may transmit a data frame 3115. Because the relay 104 indicated implicit acknowledgments would be utilized via the duration field of the CTS frame 3110, once the data 3115 is received by the relay, the relay 104 may protect the relay of data 3115 with RTS/CTS exchange 3120/3125. If the STA 106a successfully receives at least part of the RTS frame 3020 (e.g., the PLCP header that includes the Partial AID information of the STA 106b) then it may recognize it as a successful acknowledgement of the data frame 3115

After the CTS frame 3125 is received by the relay, the relay 104 relays the data received as frame 3115 from the STA 106a (TXOP Owner in this example) to the STA 106b as data frame 3130. The STA 106b may then acknowledgment the data frame 3130 using NDP acknowledgment frame 3135. Note that the RTS frame 3020 sets a NAV 3141, and the CTS 3125 confirms the NAV duration with NAV 3151.

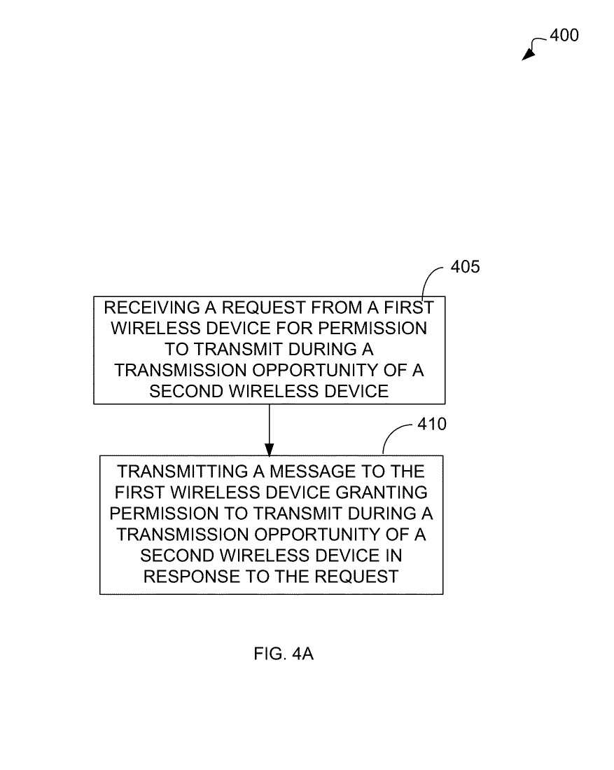

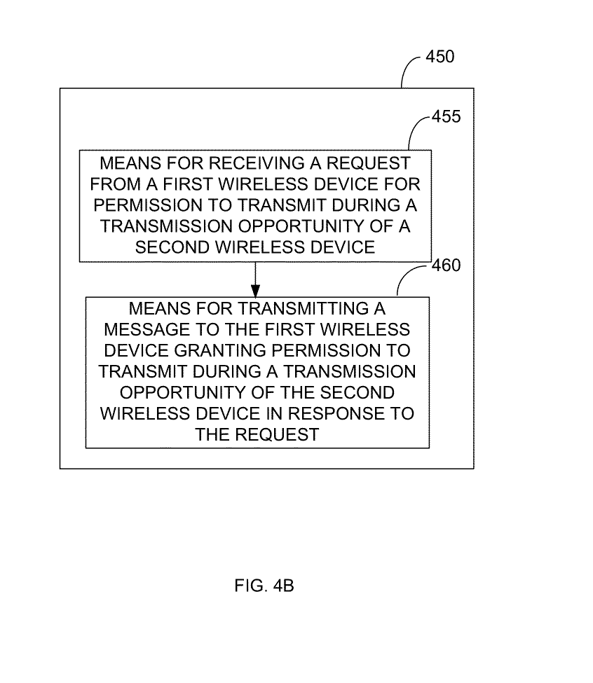

FIG. 4A is a flowchart of a process for allocating a data communications medium between a first and second wireless device on a wireless communication network. In an embodiment, the first wireless device is a station and the second wireless device is an access point. In an embodiment, process 400 may be performed by an access point, such as access point 104. In an embodiment, process 400 may be performed by wireless device 202, illustrated in FIG. 2. In one aspect, process 400 may be performed by the AP 104 illustrated in FIGS. 3A-C to perform the AP 104's respective portions of the wireless communication exchanges shown in those figures.

In processing block 405, a request from a first wireless device for permission to transmit during a transmission opportunity of a second wireless device is received. In an embodiment, the request for permission may be included as part of a ps-poll request or any type of trigger frame. In an embodiment, the request for permission may specify a duration of time for which permission to transmit is requested. I

In block 410 a message is transmitted to the first wireless device granting permission to transmit during a second wireless device transmission opportunity in response to the request. In an embodiment, the message may specify a duration of time for which permission to transmit is granted. In an embodiment, the message may specify a delay time period. In an embodiment, after the delay time period, the first wireless device may expect a frame that activates a reverse direction grant or grants permission to transmit data during a transmission opportunity of the second wireless device. In some embodiments, the first wireless device may sleep for a time based on the delay time period after receiving the transmitted message. In an embodiment, the transmitted message may be an acknowledgement message. In an embodiment, the transmitted message may be a clear-to-send message or a QOS Null message. In an embodiment, the transmitted message may be a data message. The data message may include data or may be a null data message and include no data payload. In some other aspects, the message granting permission may be an acknowledgement message.

The transmitted message may include a “more data” indication. The “more data” indication may indicate whether the second wireless device will send data to the first wireless device before the first wireless device may transmit data during a second wireless device transmission opportunity. In some aspects, if the more data indication is set, process 400 includes transmitting a downlink frame after transmission of the more data indication. In these aspects, the downlink frame indicates that the first wireless device may now transmit during the transmission opportunity of the second wireless device.

In an embodiment, if the “more data” indication is not set, the second wireless device may transmit a second message indicating the first wireless device may begin transmitting during a second wireless device transmission opportunity. In an embodiment, this second message may be a trigger frame. For example, the second message may be a clear-to-send message. In this embodiment, the clear to send message grants permission for the first wireless device to transmit in the transmission opportunity of the second wireless device.

In an embodiment, if the “more data” indication is set, then the second wireless device may transmit a different second message indicating the first wireless device may begin transmitting during a second wireless device transmission opportunity. In an embodiment, the different second message may be a data message. The data message may also include an indication that the first wireless device may begin transmitting data in a transmission opportunity of the access point. This indication may be a reverse direction grant indication.

In some aspects, process 400 may include periodically transmitting a reverse direction grant indication to the first wireless device. In some aspects, process 400 may include periodically transmitting a beacon message indicating one or more transmission opportunities of the second wireless device.

After permission is granted to the first wireless device to transmit during a transmission opportunity, process 400 may further include receiving data from the first wireless device. Before data is received, in some aspects, process 400 may include transmitting a message during the transmission opportunity. For example, the second wireless device may grant permission for the first wireless device to transmit only within a later portion of a transmission opportunity. The second wireless device may use an earlier portion of the transmission opportunity for its own purposes.

In some aspects, process 400 further includes transmitting a message canceling a previously granted permission to transmit during a transmission opportunity. In some aspects, this message is a CF-END message.

In some aspects, process 400 further includes receiving a clear to send message. The clear to send message indicates a request for extension of a contention free time period on the wireless medium. In response, some aspects include transmitting a request to send message indicating a second contention free period on the wireless medium. The second contention free period is different than the first contention free period. Some aspects further include transmitting a message on the wireless medium indicating a contention free period on the wireless medium different than the first contention free period in response to receiving the clear to send message.

FIG. 4B is a functional block diagram of an exemplary device 450 that may be employed within the wireless communication system 100. The device 450 includes means for receiving a request from a first wireless device for permission to transmit during a transmission opportunity of a second wireless device. In an embodiment, means 455 may be configured to perform one or more of the functions discussed above with respect to block 405. In an embodiment, the means for receiving a request from a first wireless device for permission to transmit during a transmission opportunity of a second wireless device may include a receiver, such as receiver 212 of FIG. 2. Means 455 may also include one or more of a processor, signal generator, transceiver, decoder, or a combination of hardware and/or software component(s), circuits, and/or module(s).

The device 450 further includes means 460 for transmitting a message to the first wireless device granting permission to transmit during a transmission opportunity of the second wireless device in response to the request. In an embodiment, means 460 may be configured to perform one or more of the functions discussed above with respect to block 410. The means 460 for transmitting a message to the first wireless device granting permission to transmit during a transmission opportunity of the second wireless device in response to the request may include a transmitter, such as transmitter 210 of FIG. 2. Means 460 may also include one or more of a processor, signal generator, transceiver, decoder, or a combination of hardware and/or software component(s), circuits, and/or module(s).

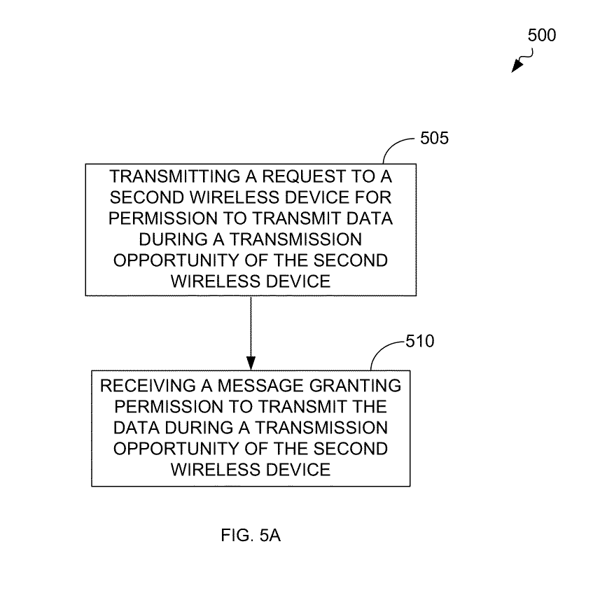

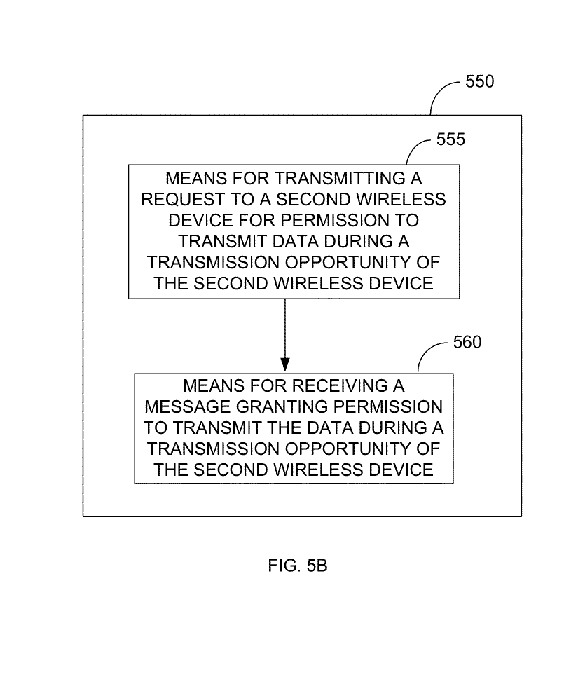

FIG. 5A is a flowchart of a process for allocating a data communications medium between a first and second wireless device on a wireless communication network. In an embodiment, process 500 may be performed by a station, such as station 106. In an embodiment, the first wireless device is a station and the second wireless device is an access point. In another embodiment, the first wireless device is an access point and the second wireless device is a station. In an embodiment, process 500 may be performed by wireless device 202, illustrated in FIG. 2. In one aspect, process 500 may be performed by the STA 106 illustrated in FIGS. 3A-C to perform the STA 106's respective portions of the wireless communication exchanges shown in those figures.

In processing block 505, a first wireless device transmits a request to a second wireless device for permission to transmit data during a transmission opportunity of the second wireless device. In an embodiment, the first wireless device may be a station. In an embodiment, the request for permission may be included as part of a ps-poll request or any trigger frame. In these aspects, process 500 may include transmitting the ps-poll request or any trigger frame comprising the request for permission to transmit. In an embodiment, the request for permission may specify a requested duration of transmission time. The duration may be an indication of the length of time for which permission to transmit data is requested. In one aspect, the request may further indicate a time period for which permission to transmit is requested. For example, the request may indicate a time period relative to a next or other beacon interval.

In block 510, a message is received granting permission to transmit the data during a transmission opportunity of the second wireless device. In an embodiment, the message may specify a duration of time for which permission to transmit is granted. In some aspects, the received message may include an indication of a length of time after which permission to transmit in a transmission opportunity of the second wireless device will be granted.

In an embodiment, process 500 may include receiving an indication of a delay time period as part of the message granting permission. In an embodiment, after the received delay time period, the first wireless device may expect a frame that activates a reverse direction grant, or grants permission to transmit data during a transmit opportunity of the second wireless device. In some embodiments, the first wireless device may enter a sleep state in response to receiving the message. The first wireless device may sleep for a time period based on the delay time period. For example, the first wireless device may sleep for a time period less than or equal to the delay time period indicated in the message.

In an embodiment, the received message may be an acknowledgement message. In an embodiment, the received message may be a data packet. The data packet may include data or may be a null data message. In an embodiment, the received message may be a clear-to-send message.

In some aspects, the received message may include a more data indication. If the more data indication is set, process 500 may further include receiving data from the second wireless device, the received data indicating that permission to transmit during the transmission opportunity has now been granted. In some aspects, the received data is a downlink frame. In response to receiving the data, process 500 may transmit data during the transmission opportunity of the second wireless device.

Some aspects of process 500 include transmitting data during a transmission opportunity of the second wireless device, based at least in part on the message received that grants permission to transmit. In some aspects, the data is transmitted to a device or node on the wireless network that is not the second wireless device, but is still transmitted during a transmission opportunity of the second wireless device.

Some aspects of process 500 further include transmitting a clear to send message. The clear to send message requests an extension of a contention free time period on the wireless medium. In some aspects, the contention free time period is a transmission opportunity of the second wireless device. In some aspects, the clear to send message includes an indication of the contention free time period. For example, the clear to send message may indicate the contention free time period based on a time reference relative to a beacon interval.

Some aspects of process 500 further include receiving a message indicating a contention free period on the wireless medium different than the first content free period. In some aspects, this message is received in response to the transmission of the clear to send message. In some aspects, this message is a request to send message.

Some aspects of process 500 further include periodically receiving a reverse direction grant indication from the second wireless device.

FIG. 5B is a functional block diagram of an exemplary device 550 that may be employed within the wireless communication system 100. The device 550 includes means 555 for transmitting a request to a second wireless device for permission to transmit data during a transmission opportunity of the second wireless device. In an embodiment, means 555 may be configured to perform one or more of the functions discussed above with respect to block 505. The means 555 for transmitting a request to a second wireless device for permission to transmit data during a transmission opportunity of the second wireless device may include a transmitter, such as transmitter 212 of FIG. 2. Means 555 may also include one or more of a processor, signal generator, transceiver, decoder, or a combination of hardware and/or software component(s), circuits, and/or module(s).

The device 550 further includes means 560 for receiving a message granting permission to transmit the data during a transmission opportunity of the second wireless device. In an embodiment, means 560 may be configured to perform one or more of the functions discussed above with respect to block 510. In an embodiment, the means for receiving a message granting permission to transmit the data during a transmission opportunity of the second wireless device may include a receiver, such as receiver 212 of FIG. 2. Means 560 may also include one or more of a processor, signal generator, transceiver, decoder, or a combination of hardware and/or software component(s), circuits, and/or module(s).

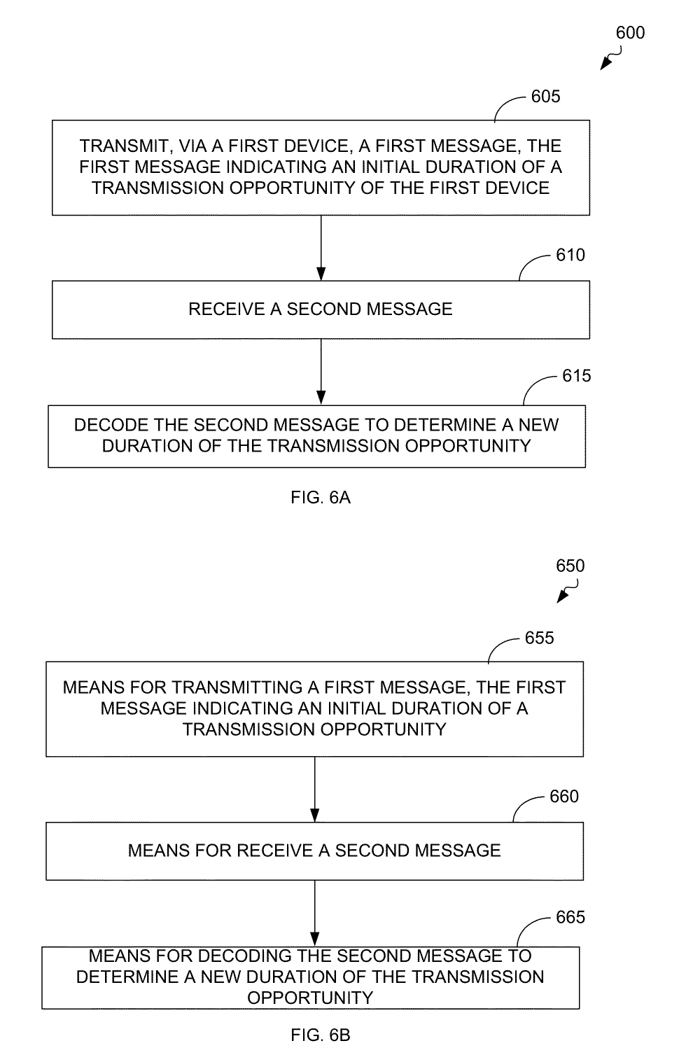

FIG. 6A is a flowchart of a process for allocating a data communications medium between a first and second wireless device on a wireless communication network. In an embodiment, process 600 may be performed by a station, such as station 106. In an embodiment, the first wireless device is a station and the second wireless device is an access point. In another embodiment, the first wireless device is an access point and the second wireless device is a station. In an embodiment, process 600 may be performed by wireless device 202, illustrated in FIG. 2. In one aspect, process 600 may be performed by the STA 106 illustrated in FIGS. 3A-C or 3F-G to perform at least a portion of AP 104's respective portions of the wireless communication exchanges shown in the figures. In some aspects, process 600 may be performed by the STA 106a of FIG. 3H and/or FIG. 3I.

In block 605, a first message is transmitted by a first wireless device. The first message indicates an initial duration of a transmission opportunity of the first wireless device. In some aspects, the first message is generated as a request-to-send message. In some aspects, the first message is generated as a PS-Poll frame or as a trigger frame. In some of these aspects, the initial duration may be indicated by a duration/ID field, such as field 382b shown in FIG. 3D. In some aspects, a first timer (e.g., NAV counter) is initiated at the receivers of the frame based on the duration value included in the frame. The first counter may count down at a uniform rate.

In some aspects, block 605 includes generating the first message to indicate whether the first device grants permission to utilize at least a portion of the transmission opportunity to relay data transmitted by the first device. In some aspects, the permission is indicated in a frame control field of the first message. Specifically, in some of these aspects, the permission is indicated in an order field or a relayed frame field of the first message.

In block 610, a second message is received. In some aspects, the second message is a response to the first message. The second message may be received SIFS time after transmission of the first message is complete in some aspects.

The second message is then decoded in block 615 to determine a new duration of the transmission opportunity. In some aspects, the second message is decoded as a clear-to-send message. In some aspects the second message is a request-to-send message. In some aspects, the new duration is decoded to be longer than the duration indicated in the first message. In some aspects, upon decoding the new duration, the first device initiates a second timer (e.g. NAV counter) at the receiver STAs that receive this frame. The second timer may also count down at a uniform rate.

In some aspects, the second message is further decoded to determine whether an explicit or implicit acknowledgment procedure will be used for relayed data during the transmission opportunity. This decoding may be conditional on whether the first device granted permission to relay data during the transmission opportunity, as discussed above with respect to block 605. In some aspects, a response indication field in a PLCP header of the second message may be decoded to determine the acknowledgment procedure, as discussed above with respect to FIGS. 3H-3I. In some aspects, the explicit or implicit acknowledgment procedure will be determined based on whether the second message updates a network allocation vector (NAV). For example, if the second message leaves the NAV unchanged, an implicit acknowledgment procedure will be used, whereas if the second message extends the duration of the NAV, explicit acknowledgments will be utilized. Once the acknowledgment procedure is determined, whether data transmitted has been acknowledged will be based on the determined acknowledgment procedure.

Some aspects of process 600 further include transmitting a third message indicating whether a second device has permission to extend the duration of the transmission opportunity. In certain aspects, the permission to extend the duration of the transmission opportunity is indicated by a duration field included in the third message. If the duration field in the third message points to the instant of the expiration of the first timer, a permission to extend the duration is not allowed and the second wireless device shall update the duration fields of the frames transmitted in the same TXOP based on the duration indicated by the first wireless device. If the value of the duration field points to the instant of the expiration of the second timer, a permission to extend the duration is allowed and both wireless devices shall update the duration fields of the frames that follow, transmitted in that same TXOP, based on the duration indicated by the second wireless device.

In some aspects, the permission to extend the duration of the transmission opportunity is indicated by the transmission of the third message itself. If the second device replies with the third message, after a given amount of time (e.g., SIFS time) it is an indication of permission to transmit. Failure to receive the third message is an indication for the second device that it is not allowed to extend the duration of the transmission opportunity. In some aspects, the first message and the third message are the same message. In some aspects, the third message is a clear-to send message. In certain aspects the clear to send message may be of null data packet type. For example, as shown in FIG. 3F, a device, such as the AP 104 of FIG. 3F, may transmit a request to send message such as request to send message 380. This message may indicate, via an order field in a frame control field or other field, whether permission to extend the duration indicated by the request-to-send is permitted by a receiving device, which may be specified in the receiving address field 382c of request-to-send message 380 in some aspects. In some aspects, setting the order bit in the frame control field, or setting another reserved field in the request-to-send frame 380 may provide the indication that permission is granted. In some aspects that do not utilize a request-to-send frame, any bit or series of bits may be used to provide such an indication.

FIG. 6B is a functional block diagram of an exemplary device 650 that may be employed within the wireless communication system 100. The device 650 includes means 655 for transmitting a first message, the first message indicating an initial duration of a transmission opportunity. In an embodiment, means 655 may be configured to perform one or more of the functions discussed above with respect to block 605. The means for transmitting 655 may include a transmitter, such as transmitter 210 of FIG. 2. Means 655 may also include one or more of a processor, signal generator, transceiver, decoder, or a combination of hardware and/or software component(s), circuits, and/or module(s).

The device 650 further includes means 660 for receiving a second message. In an embodiment, means 660 may be configured to perform one or more of the functions discussed above with respect to block 610. In an embodiment, the means for receiving 660 may include a receiver, such as receiver 212 of FIG. 2. Means 660 may also include one or more of a processor, signal generator, transceiver, decoder, or a combination of hardware and/or software component(s), circuits, and/or module(s).

The device 650 further includes means 665 for decoding the second message to determine a new duration of the transmission opportunity. In an embodiment, means 665 may be configured to perform one or more of the functions discussed above with respect to block 615. In an embodiment, the means for receiving 665 may include a processor, such as processor 204 of FIG. 2. Means 665 may also include one or more of a processor, signal generator, transceiver, decoder, or a combination of hardware and/or software component(s), circuits, and/or module(s).

Some aspects of process 600 may include process 1200, discussed below with respect to FIG. 12A. For example, in some aspects, the first message of process 600 and the first message of process 1200 are equivalent.

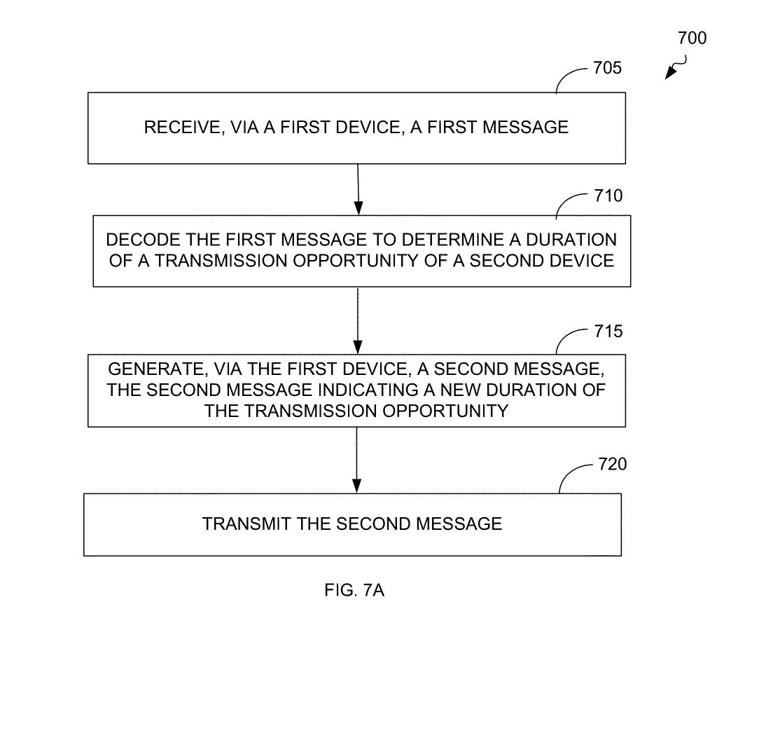

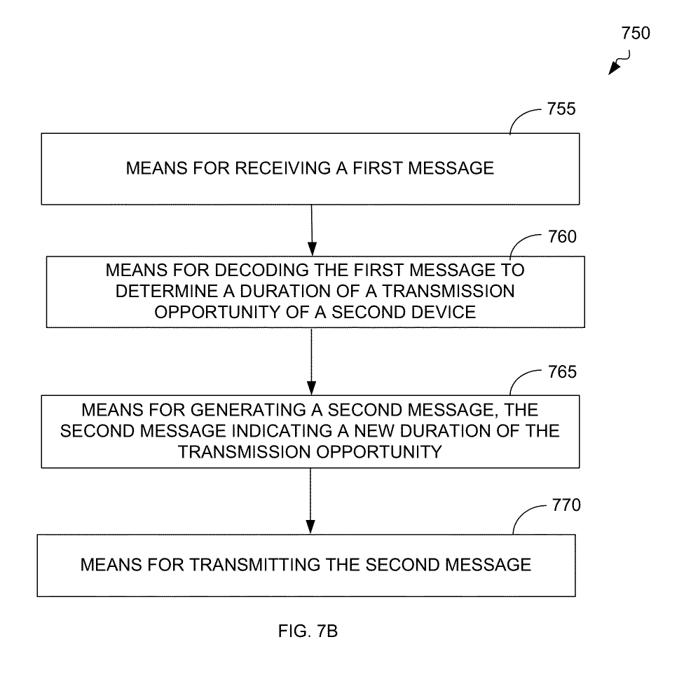

FIG. 7A is a flowchart of a process for allocating a data communications medium between a first and second wireless device on a wireless communication network. In an embodiment, process 700 may be performed by a station, such as station 106. In an embodiment, the first wireless device is a station and the second wireless device is an access point. In another embodiment, the first wireless device is an access point and the second wireless device is a station. In another embodiment, both the first wireless device and the second wireless device are stations. In some aspects, the first device is a TXOP responder while the second wireless device is a TXOP owner.

In an embodiment, process 700 may be performed by wireless device 202, illustrated in FIG. 2. In one aspect, process 700 may be performed by the STA 106 illustrated in FIGS. 3A-C or 3F or 3G to perform at least a portion of STA 106(a)'s respective portions of the wireless communication exchanges shown in the figures. In some aspects, process 700 may be performed by the AP 104 (relay) described with respect to FIG. 3H and/or FIG. 3I.

In block 705, a first message is received by a first device. In block 710, the first message is decoded to determine a duration of a transmission opportunity of a second device. For example, in some aspects, the first message is decoded as a request-to-send message, which may include a duration/ID field, such as duration/ID field 382b in request-to-send frame 380. The duration/ID field may indicate the duration of a transmission opportunity.

In block 715, a second message is generated via the first device. In some aspects, the second message is generated as a clear-to-send message. The second message is generated to indicate a new duration of the transmission opportunity. In some aspects, a device performing process 700 may have an amount of data to transmit that is greater than the duration indicated in the first message. To ensure NAV protection for a larger portion of data the first device may have available for transmission, the first device may generate the second message as described in block 715.

When transmitted to a TXOP Owner, the second message may extend the NAV of a wireless network and ensure a data transmission longer than the duration indicated in the first message can be completed successfully with adequate protection from collisions. Generally therefore, if a device performing process 700 determines the NAV needs to be extended, the new duration will be greater than the original duration indicated in the first message.

In some aspects, the indicated new duration of block 715 may be determined based on either equation (1) or (2) described above and reproduced below:

D=T_{END-NAV}+T_{PENDING}−T_{PPDU}<=D<=T_{TXOP}_{_{—}}_{REMAINING}−T_{PPDU} (1)

D=T_{END-NAV}+T_{PENDING}−T_{PPDU}<=D (2)

where:
T_{SINGLE-MSDU} is the estimated time required for the transmission of the allowed frame exchange sequence defined in 8.4.2.28 (EDCA Parameter Set element) (for a TXOP limit value of 0), including applicable IFSs (#156).
T_{PENDING} is the estimated time required for the transmission of
   Pending MPDUs of the same AC
   Any associated immediate response frames
   Any NDP transmissions and explicit feedback response frames
   Applicable (#156) IFSs
   Any RDG
T_{TXOP} is the value of dot11EDCATableTXOPLimit (dot11EDCAQAP-TableTXOPLimit for the AP) for that AC.
T_{TXOP-REMAINING} is T_{TXOP} less the time already used time within the TXOP.
T_{END-NAV} is the remaining duration of any NAV set by the TXOP holder, or 0 if no NAV has been established.
T_{PPDU} is the time required for transmission of the current PPDU.

In block 720, the second message is transmitted on the wireless network.

Some aspects of process 700 further include receiving a third message, and decoding the third message to determine whether the device performing process 700 has permission to extend the duration of the transmission opportunity of the second device. In some aspects, the third message is the first message. In these aspects, if the third message indicates the device performing process 700 does not have permission to extend the NAV or duration, then process 700 may not perform blocks 715 or 720 in these aspects.

In some aspects, values of duration fields (if any) of frames transmitted by the TXOP owner or the TXOP responder within a TXOP indicate that the NAV expires at the same instant of time as previously indicated by another duration field in a previously transmitted frame within the same TXOP. Frames transmitted during a TXOP that do not include a duration field do not affect the duration of a current NAV.

Some aspects of process 700 further include decoding the first message to determine whether permission is granted to relay data transmitted by the second device during the transmission opportunity. For example, in some aspects, the first message of process 700 is equivalent to the first message of process 1100, discussed below. In some of these aspects, the second message is further generated to indicate an acknowledgment procedure for data relayed during the transmission opportunity. For example, in some aspects, the second message is a non-NDP CTS message. In these aspects, a response indication field of a S1G PLCP header of the second message may indicate the acknowledgment procedure. In some aspects, an explicit acknowledgment procedure may be indicated by generating the response indication field to have a first value. In some aspects, an implicit acknowledgment procedure may be indicated by generating the response indication field to have a second value.

In some aspects, the second message may be a null data packet CTS message, such as NDP CTS message 3010 of FIG. 3H or 3110 of FIG. 3I. If explicit acknowledgments are used, a duration field of the second message may extend a NAV defined by the first message. In some aspects, the duration field is based on an estimated time for transmission of a frame to be relayed and a corresponding response if the acknowledgment procedure indicates an explicit acknowledgment procedure. The duration field may be set in substantial conformance to the discussion of FIG. 3H above. If implicit acknowledgments are used, the duration field may be set in substantial conformance with the discussion of FIG. 3I, discussed above. For example, the duration field of the second message may not extend a NAV duration defined by the first message when implicit acknowledgments are used.

In relaying aspects of process 700, process 700 further includes receiving data from the second device; and acknowledging the data based on the indicated acknowledgment procedure. If an explicit acknowledgment procedure is in use, process 700 further includes transmitting a null data packet acknowledgement frame to the second device in response to receiving the data, as discussed above with respect to FIG. 3H.

If implicit acknowledgments are being used, process 700 further includes transmitting a request-to-send message to a third device in response to receiving the data, as discussed above with respect to FIG. 3I. When explicit acknowledgements are used, process 700 may also include transmitting a request to send message to a third device. For example, the RTS message may be transmitted SIPS time after the NDP acknowledgement, such as NDP acknowledgment 3020 of FIG. 3H.

Some implementations may combine process 700 with process 1100, discussed below with respect to FIG. 11A. For example, the first message of process 700 may be the same message as the first message of process 1100. Additionally, the second message of process 700 may be equivalent to the response message discussed with respect to process 1100.

FIG. 7B is a functional block diagram of an exemplary device 750 that may be employed within the wireless communication system 100. The device 750 includes means 755 for receiving a first message. In an embodiment, means 755 may be configured to perform one or more of the functions discussed above with respect to block 705. The means for receiving 755 may include a receiver, such as receiver 212 of FIG. 2. Means 755 may also include one or more of a processor, signal generator, transceiver, decoder, or a combination of hardware and/or software component(s), circuits, and/or module(s).

The device 750 further includes means 760 for decoding the first message to determine a duration of a transmission opportunity of a second device. In an embodiment, means 760 may be configured to perform one or more of the functions discussed above with respect to block 710. In an embodiment, the means for decoding 760 may include a processor, such as processor 204 of FIG. 2. Means 760 may also include one or more of a processor, signal generator, transceiver, decoder, or a combination of hardware and/or software component(s), circuits, and/or module(s).

The device 750 further includes means 765 for generating a second message, the second message indicating a new duration of the transmission opportunity. In an embodiment, means 765 may be configured to perform one or more of the functions discussed above with respect to block 715. In an embodiment, the means for generating 765 may include a processor, such as processor 204 of FIG. 2. Means 765 may also include one or more of a processor, signal generator, transceiver, decoder, or a combination of hardware and/or software component(s), circuits, and/or module(s).

The device 750 further includes means 770 for transmitting the second message. In an embodiment, means 770 may be configured to perform one or more of the functions discussed above with respect to block 720. In an embodiment, the means for transmitting 770 may include a transmitter, such as transmitter 210 of FIG. 2. Means 770 may also include one or more of a processor, signal generator, transceiver, decoder, or a combination of hardware and/or software component(s), circuits, and/or module(s).

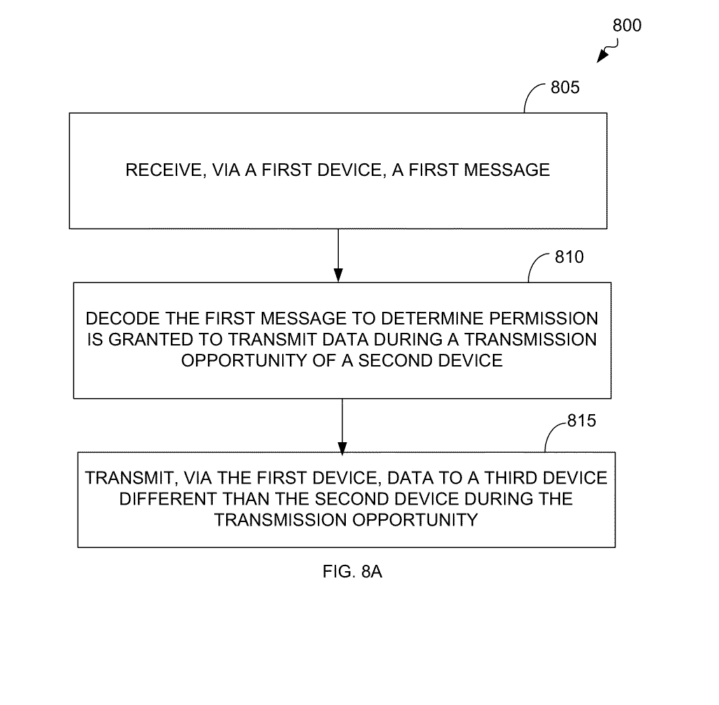

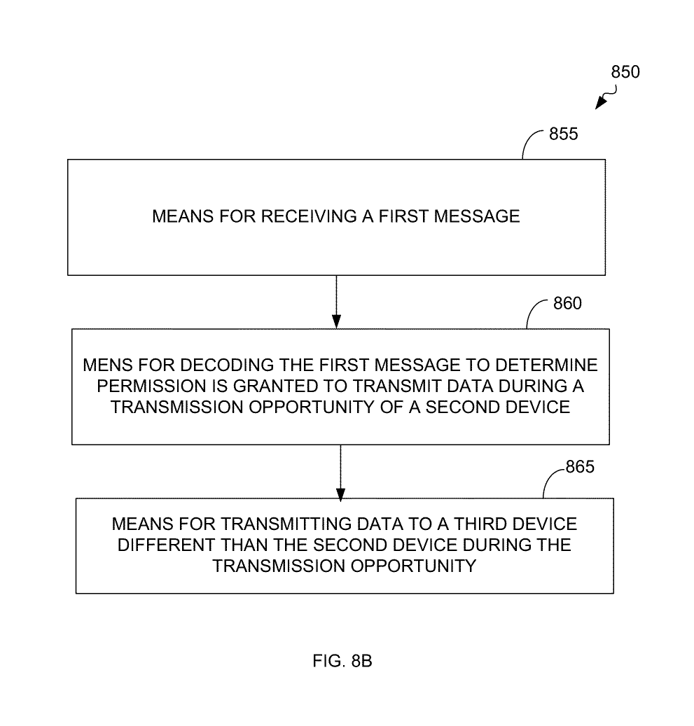

FIG. 8A is a flowchart of a process for allocating a data communications medium between a first and second wireless device on a wireless communication network. In an embodiment, process 800 may be performed by a station, such as station 106. In an embodiment, the first wireless device is a station and the second wireless device is an access point. In another embodiment, the first wireless device is an access point and the second wireless device is a station. In another embodiment, both the first wireless device and the second wireless device are stations. In some aspects, the first wireless device is a TXOP responder while the second wireless device is a TXOP owner.

In an embodiment, process 800 may be performed by wireless device 202, illustrated in FIG. 2. In one aspect, process 800 may be performed by the STA 106a illustrated in FIG. 3F to perform at least a portion of STA 106(a)'s wireless communication exchanges shown in the figures.

In block 805, a message is received via a first wireless device. In block 810, the first message is decoded to determine that permission is granted to transmit data during a transmission opportunity of a second wireless device. In some aspects, the first message may be part of a reverse direction grant as described previously. In some aspects, the first message is decoded as a request-to-send message. In block 815, data is transmitted by the first wireless device to a third wireless device during the transmission opportunity. The third wireless device is different than the second wireless device. As demonstrated in FIG. 3F, a TXOP responder may transmit data to a 3^{rd} device, such as STA 106b in FIG. 3F, during a transmission opportunity of a second device, or TXOP owner. In the case of FIG. 3F, the TXOP owner is of course the AP 104.

Some aspects of process 800 further include generating and transmitting a third message indicating the first device will transmit data to a device other than the second device. In some aspects, the third message is generated as a data or acknowledgment message. In some aspects, process 800 includes setting a more data field, or a relayed frame bit in a NDP acknowledgment frame or in a data message or other message to provide the indication.

FIG. 8B is a functional block diagram of an exemplary device 850 that may be employed within the wireless communication system 100. The device 850 includes means 855 for receiving a first message. In an embodiment, means 855 may be configured to perform one or more of the functions discussed above with respect to block 805. The means for receiving 855 may include a receiver, such as receiver 212 of FIG. 2. Means 855 may also include one or more of a processor, signal generator, transceiver, decoder, or a combination of hardware and/or software component(s), circuits, and/or module(s).

The device 850 further includes means 860 for decoding the first message to determine permission is granted to transmit data during a transmission opportunity of a second device. In an embodiment, means 860 may be configured to perform one or more of the functions discussed above with respect to block 810. In an embodiment, the means for decoding 860 may include a processor, such as processor 204 of FIG. 2. Means 860 may also include one or more of a processor, signal generator, transceiver, decoder, or a combination of hardware and/or software component(s), circuits, and/or module(s).

The device 850 further includes means 865 for transmitting data to a third device different than the second device during the transmission opportunity. In an embodiment, means 865 may be configured to perform one or more of the functions discussed above with respect to block 815. In an embodiment, the means for transmitting 865 may include a transmitter, such as transmitter 210 of FIG. 2. Means 865 may also include one or more of a processor, signal generator, transceiver, decoder, or a combination of hardware and/or software component(s), circuits, and/or module(s).

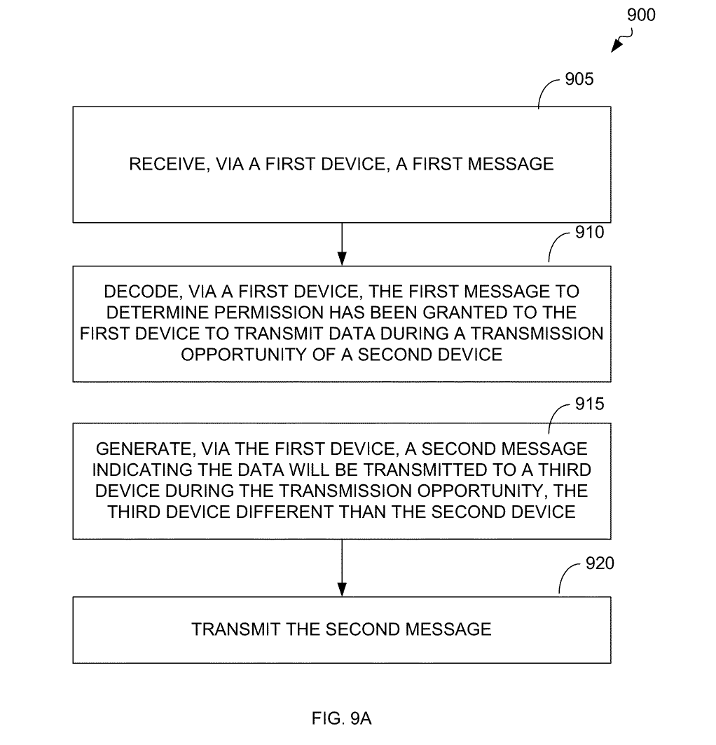

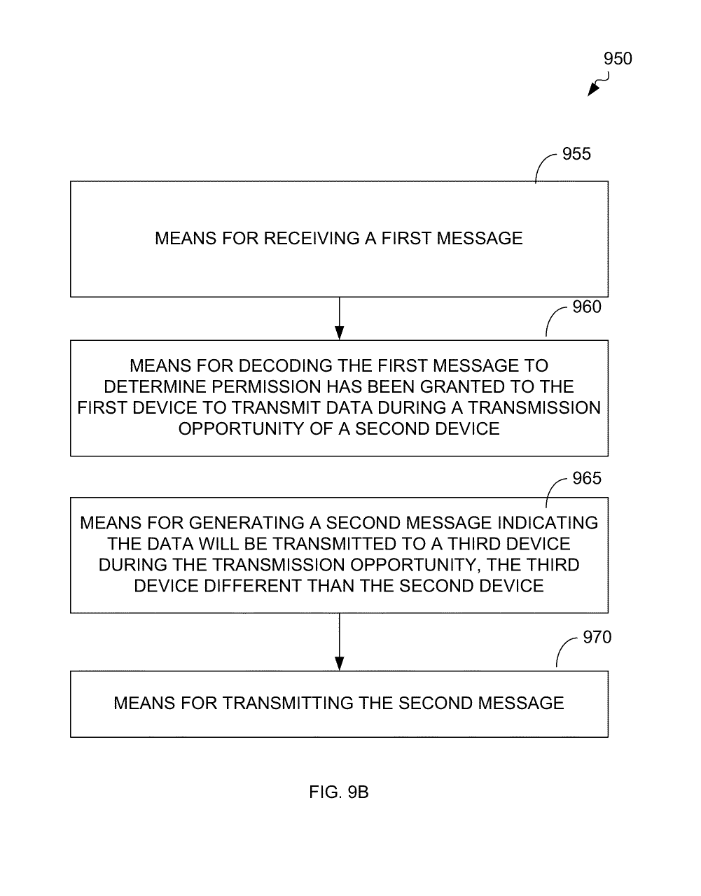

FIG. 9A is a flowchart of a process for allocating a data communications medium between a first and second wireless device on a wireless communication network. In an embodiment, process 900 may be performed by a station, such as station 106. In an embodiment, the first wireless device is a station and the second wireless device is an access point. In another embodiment, the first wireless device is an access point and the second wireless device is a station. In another embodiment, both the first wireless device and the second wireless device are stations. In some aspects, the first wireless device is a TXOP responder while the second wireless device is a TXOP owner.

In an embodiment, process 900 may be performed by wireless device 202, illustrated in FIG. 2. In one aspect, process 900 may be performed by the STA 106a illustrated in FIG. 3F to perform at least a portion of STA 106a's wireless communication exchanges shown in the figures.

In block 905, a first message is received by a first wireless device. In block 910, the first wireless message is decoded to determine permission has been granted to transmit data during a transmission opportunity of a second wireless device.

In block 910, a second message is generated by first device, the message is generated to indicate data will be transmitted to a third wireless device during the transmission opportunity.

In block 915, a second message is generated to indicate the data will be transmitted to a third device during the transmission opportunity. The third wireless device is different than the second wireless device. As shown in FIG. 3F, a TXOP responder may transmit an indication to a TXOP owner that it intends to transmit data to a 3^{rd} device, such as STA 106b, during the TXOP owner's transmission opportunity.

In block 920, the second message is transmitted on the wireless network. In some aspects, the second message is generated as a data or acknowledgment message. In some aspects, process 900 includes setting a more data field, or a relayed frame field in a NDP acknowledgment, or in a data message to provide the indication. Process 900 may also include transmitting the data to the third wireless device.

FIG. 9B is a functional block diagram of an exemplary device 950 that may be employed within the wireless communication system 100. The device 950 includes means 955 for receiving a first message. In an embodiment, means 955 may be configured to perform one or more of the functions discussed above with respect to block 905. The means for receiving 955 may include a receiver, such as receiver 212 of FIG. 2. Means 955 may also include one or more of a processor, signal generator, transceiver, decoder, or a combination of hardware and/or software component(s), circuits, and/or module(s).

The device 950 further includes means 960 for decoding the first message to determine permission is granted to transmit data during a transmission opportunity of a second device. In an embodiment, means 960 may be configured to perform one or more of the functions discussed above with respect to block 910. In an embodiment, the means for decoding 960 may include a processor, such as processor 204 of FIG. 2. Means 960 may also include one or more of a processor, signal generator, transceiver, decoder, or a combination of hardware and/or software component(s), circuits, and/or module(s).

The device 950 further includes means 965 for generating a second message indicating the data will be transmitted to a third device during the transmission opportunity, the third device different than the second device. In an embodiment, means 965 may be configured to perform one or more of the functions discussed above with respect to block 915. In an embodiment, the means for generating 965 may include a processor, such as processor 204 of FIG. 2. Means 965 may also include one or more of a processor, signal generator, transceiver, decoder, or a combination of hardware and/or software component(s), circuits, and/or module(s).

The device 950 further includes means 970 for transmitting the second message. In an embodiment, means 970 may be configured to perform one or more of the functions discussed above with respect to block 920. In an embodiment, the means for transmitting 965 may include a transmitter, such as transmitter 210 of FIG. 2. Means 970 may also include one or more of a processor, signal generator, transceiver, decoder, or a combination of hardware and/or software component(s), circuits, and/or module(s).

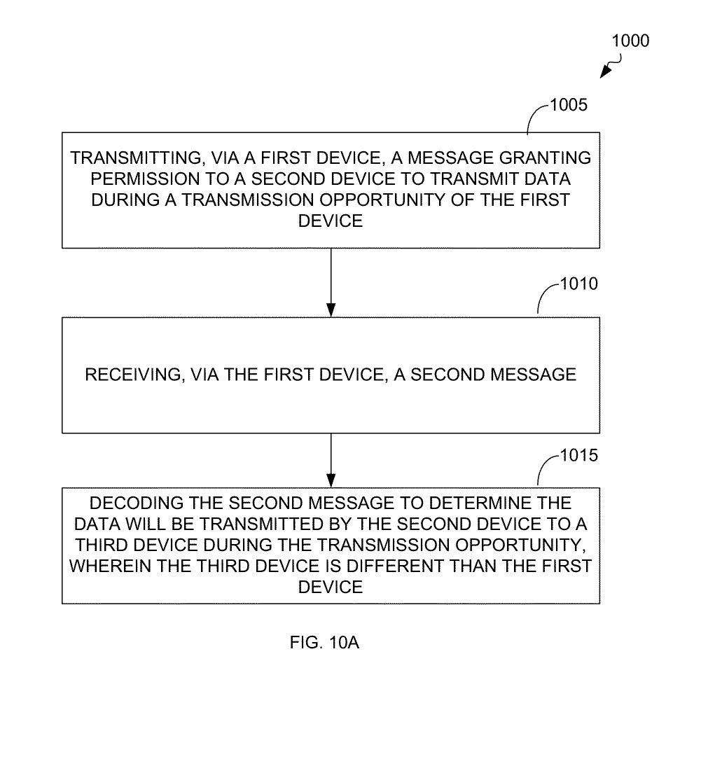

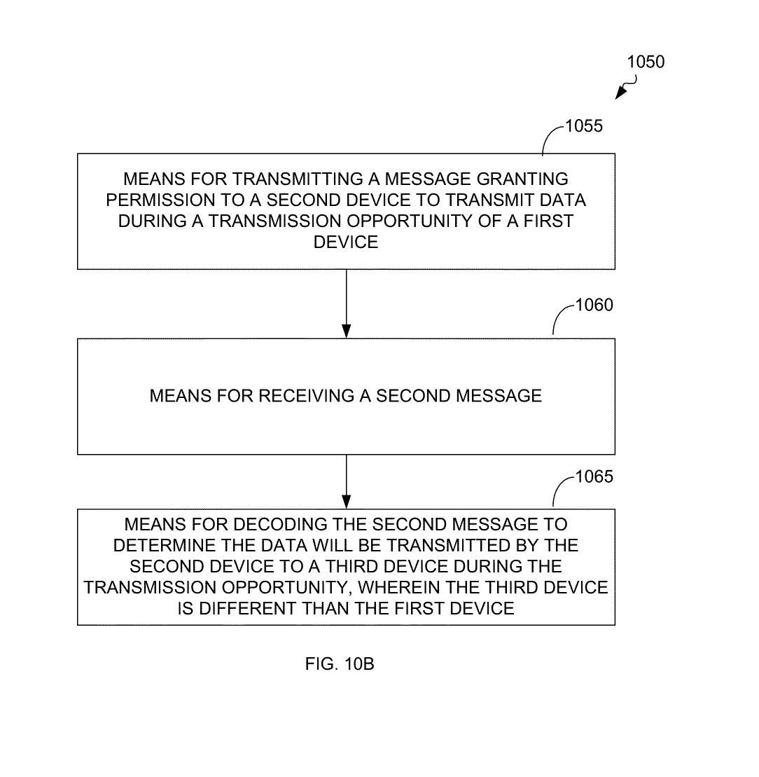

FIG. 10A is a flowchart of a process for allocating a data communications medium between a first and second wireless device on a wireless communication network. In an embodiment, process 1000 may be performed by a station, such as station 106. In an embodiment, the first wireless device is a station and the second wireless device is an access point. In another embodiment, the first wireless device is an access point and the second wireless device is a station. In another embodiment, both the first wireless device and the second wireless device are stations. In some aspects, the first wireless device is a TXOP owner while the second wireless device is a TXOP responder.

In block 1005, a first message is transmitted by a first device. The first message grants permission to a second device to transmit data during a transmission opportunity of the first device. In block 1010, a second message is received by the first device.

In block 1015, the second message is decoded to determine that the data will be transmitted by the second device to a third device during the transmission opportunity. The third device is different than the first device. In some aspects, the second message is decoded as a data or an acknowledgment message. In some aspects, process 1000 includes decoding a more data field or a relayed frame field of the second message to determine that the data will be transmitted by the second device to a third device during the transmission opportunity.

FIG. 10B is a functional block diagram of an exemplary device 1050 that may be employed within the wireless communication system 100. The device 1050 includes means 1055 for transmitting a message granting permission to a second device to transmit data during a transmission opportunity of a first device. In an embodiment, means 1055 may be configured to perform one or more of the functions discussed above with respect to block 1005. In an embodiment, the means for transmitting 1055 may include a transmitter, such as transmitter 210 of FIG. 2. Means 1055 may also include one or more of a processor, signal generator, transceiver, decoder, or a combination of hardware and/or software component(s), circuits, and/or module(s).

The device 1050 further includes means 1060 for receiving a second message. In an embodiment, means 1060 may be configured to perform one or more of the functions discussed above with respect to block 1010. The means for receiving 1060 may include a receiver, such as receiver 212 of FIG. 2. Means 1060 may also include one or more of a processor, signal generator, transceiver, decoder, or a combination of hardware and/or software component(s), circuits, and/or module(s).

The device 1050 further includes means 1065 for decoding the first message to determine the data will be transmitted by the second device to a third device during the transmission opportunity of the first device, wherein the third device is different than the first device. In an embodiment, means 1065 may be configured to perform one or more of the functions discussed above with respect to block 1015. In an embodiment, the means for decoding 1065 may include a processor, such as processor 204 of FIG. 2. Means 1065 may also include one or more of a processor, signal generator, transceiver, decoder, or a combination of hardware and/or software component(s), circuits, and/or module(s).

FIG. 11A is a flowchart of a process for allocating a data communications medium between a first and second wireless device on a wireless communication network. In an embodiment, process 1100 may be performed by a station, such as station 106. In an embodiment, the first wireless device is a station and the second wireless device is an access point. In another embodiment, the first wireless device is an access point and the second wireless device is a station. In another embodiment, both the first wireless device and the second wireless device are stations. In some aspects, the second wireless device is a TXOP owner while the first wireless device is a TXOP responder. In some aspects, process 1100 is performed by the AP relay 104 in FIG. 3H. In some other aspects, process 1100 is performed by the AP relay 104 in FIG. 3I.

In block 1105, a first message is received by a first wireless device. The first message is from a second device. For example, the first message may be a request-to-send message, such as request-to-send message 3005 of FIG. 3H. In some aspects, the first message of block 1105 is the first message of process 600, discussed with respect to FIG. 6A, the first message of process 700 described with respect to FIG. 7A, the first message of process 800, described with respect to FIG. 8A, and/or the first message of process 900 discussed with respect to FIG. 9A,

In block 1110, the first message is decoded to determine whether permission is granted to the first device to utilize at least a portion of a transmission opportunity of the second device to relay data transmitted by the second device. For example, referring back to FIG. 3H, the transmission opportunity may be for the STA 106a. In other words, the STA 106a (or the second device in process 1100) may be the TXOP owner. Permission may be indicated in some aspects, by the order field 387k of the first message, discussed with respect to FIG. 3E-1, or order field 388k of FIG. 3E-2. For example, if the order field has a value of one (1), it may indicate permission is granted. If the value is zero, it may indicate the second device is not providing use of its TXOP for relay purposes. The order field 387k may also be referred to as a relayed frame field in some aspects.

In block 1115, a response to the first message is generated. The response is generated to indicate an acknowledgment procedure for data that may be relayed by the first wireless device or to indicate intention to use the granted TXOP. The acknowledgment procedure may define whether explicit or implicit acknowledgments are used for the relayed data.

The acknowledgment procedure may be indicated in some aspects by a response indication field in a S1G field of the PLCP Preamble of the response, which, in some aspects, is a clear to send message. If the response indication is set to a value of “long response” (three (3) in some aspects), the response may indicate explicit acknowledgment will be used. If the response indication of the response message is set to “no response” (zero (0) in some aspects, the response may indicate implicit acknowledgments will be used when relaying data.

The acknowledgment procedure may be indicated in some aspects by a duration field of the response message, which, in some aspects, is a null data packet acknowledgment message, and/or a NDP clear to send message. As discussed with respect to FIG. 3H, if the first wireless device determines that explicit acknowledgments will be used when data is relayed, it may set the duration field to a value “D,” based on the equation below:

D=min(T_{RTS}+T_{PENDING}−T_{PPDU};T_{TXOP}_{_{—}}_{REMAINING}−T_{PPDU})<=D<=T_{TXOP}_{_{—}}_{REMAINING}−T_{PPDU},

Where:
T_{RTS} is a value of the Duration/ID field of the S1G RTS frame that elicited the response,
T_{PPDU} is a time, in microseconds, between the end of the PPDU carrying the RTS frame and the end of the of the NDP CTS,
T_{PENDING} is an estimated time for the transmission of the frame to be forwarded and its response if required plus applicable IFS durations, and
T_{TXOP}_{_{—}}_{REMAINING} is equal to any T_{TXOP} minus T_{RTS}, where the T_{TXOP} is the estimated amount of time of the current TXOP started by the TXOP initiator as known by the relay.

If the first wireless device determines that implicit acknowledgment will be utilized, a response indication of the response may be set to “No Response” (Zero (0) in some aspects). The duration field of the response message may also be set as described above with respect to FIG. 3I.

As discussed above, a duration/ID field of a second RTS frame transmitted by the relay may be less than or equal to the TXOP for the access category minus an estimated time since the beginning of reception of the first RTS frame (which had the relayed frame field set to a first value (e.g. one) and was transmitted by the relay-shared TOP owner. The duration field of the second message may function to set a duration of a NAV used to protect the relayed transmissions during a transmission opportunity.

In block 1120, the response message, is transmitted. Block 1120 may be performed in some aspects by the transmitter 210. In some aspects, the response message is equivalent to the second message of process 600, discussed with respect to FIG. 6A, the second message of process 700, discussed with respect to FIG. 7A, and/or the second message of process 1000, discussed with respect to FIG. 10A.

When an explicit acknowledgment procedure is utilized, as described above with respect to FIG. 3H, and frames 3020, 3025, and 3030, process 1100 may further include receiving data (3015) from the second device, acknowledging the data (via NDP acknowledgment 3020), and then relaying or transmitting the data (3025) to a third device. In some aspects, transmission (relaying) of the data to the third device may occur SIFS time after transmission of the acknowledgment (such as NDP acknowledgement 3020 of FIG. 3H) has completed.

When an implicit acknowledgment procedure is utilized, as described above with respect to FIG. 3I, and frames 3115, 3020, 3125, and 3130, process 1100 may further include receiving data (3115), transmitting a second request-to-send message (3020), receiving a corresponding CTS message (3125), and relaying the data frame 3115 (as data frame 3130). Process 1100 may further include receiving an acknowledgment frame 3135 for the data frame 3130.

FIG. 11B is a functional block diagram of an exemplary device 1150 that may be employed within the wireless communication system 100. The device 1150 includes means 1155 for receiving a first message from a second device. In an embodiment, means 1155 may be configured to perform one or more of the functions discussed above with respect to block 1105. In an embodiment, the means for receiving 1155 may include a receiver, such as r4eceiver 212 of FIG. 2. Means 1155 may also include one or more of a processor, signal generator, transceiver, decoder, or a combination of hardware and/or software component(s), circuits, and/or module(s).

The device 1150 further includes means 1160 for decoding the first message to determine permission is granted to the first device to utilize at least a portion of a transmission opportunity of the second device to relay data transmitted by the second device In an embodiment, means 1160 may be configured to perform one or more of the functions discussed above with respect to block 1110. The means for decoding 1160 may include a processor, such as processor 204 of FIG. 2. Means 1160 may also include one or more of a processor, signal generator, transceiver, decoder, or a combination of hardware and/or software component(s), circuits, and/or module(s).

The device 1150 further includes means 1165 for generating a response to the first message, the response generated to indicate an acknowledgement procedure for the relayed data. In an embodiment, means 1165 may be configured to perform one or more of the functions discussed above with respect to block 1115. In an embodiment, the means for generating 1165 may include a processor, such as processor 204 of FIG. 2. Means 1165 may also include one or more of a processor, signal generator, transceiver, decoder, or a combination of hardware and/or software component(s), circuits, and/or module(s).

The device 1150 further includes means 1170 for transmitting the response to the second device. In an embodiment, means 1170 may be configured to perform one or more of the functions discussed above with respect to block 1120. In an embodiment, the means for transmitting 1170 may include a transmitter, such as transmitter 210 of FIG. 2. Means 1170 may also include one or more of a processor, signal generator, transceiver, decoder, or a combination of hardware and/or software component(s), circuits, and/or module(s).

FIG. 12A is a flowchart of a process for relaying data over a wireless communications network. In an embodiment, process 1200 may be performed by a station, such as a station 106. In an embodiment, the first wireless device is a station and the second wireless device is an access point. In another embodiment, the first wireless device discussed below is an access point and the second wireless device is a station. In another embodiment, both the first wireless device and the second wireless device are stations. In some aspects, the first wireless device is a TXOP owner while the second wireless device is a TXOP responder and/or a relay. In some aspects, process 1200 is performed by the STA 106a of FIG. 3H or FIG. 3I.

In block 1205, a first message is generated by a first device. The first message is generated to indicate whether permission is granted to relay data transmitted by the first device during a transmission opportunity of the first device. In some aspects, the first message is generated to indicate the permission in a frame control field of the first message. Specifically, a relayed frame field and/or an order field, such as order field 387k of FIG. 3E-1 or order field 388k of FIG. 3E-2 may be used to indicate whether permission to relay the data during the TXOP is granted. In some aspects, the generated first message is a request-to-send message, such as the request-to-send message 3005 illustrated in FIG. 3H or the request-to-send message 3105 illustrated in FIG. 3I. In some aspects, the first message of block 1205 may be the message transmitted in block 1005 of FIG. 10A. In some aspects, the first message of block 1205 may be the first message of block 605 of FIG. 6A.

In block 1210, the first message is transmitted.

Some aspects of process 1200 further include receiving a second message acknowledging the first message. For example, the second message may be a null data packet acknowledgement, or a null data packet clear-to-send message, such as NDP CTS message 3010 of FIG. 3H and/or NDP CTS message 3110 of FIG. 3I. Some aspects of process 1200 may decode the second message to determine an acknowledgment procedure that will be used for data relayed during the transmission opportunity. For example, whether explicit acknowledgments will be performed for relayed data, or whether an implicit acknowledgment procedure will be used may be determined by decoding the second message. In some aspects, a response indication field of a S1G PLCP preamble of the second message may be decoded to determine the acknowledgment procedure. If the response indication has a first value (for example “Long Response” or three (3) in some aspects), an explicit acknowledgment procedure may be indicated by the second message, while if the response indication has a second value (for example “No Response” or zero (0) in some aspects), an implicit acknowledgement procedure may be utilized.

In some aspects, the second message may be further decoded to determine a new duration of a NAV for the wireless communications network. In some aspects, if the second message indicates a different expiration time of the NAV than indicated by the first message, an explicit acknowledgment procedure will be used, while if the NAV expiration is unchanged by the second message, an implicit acknowledgment procedure will be used. In some aspects, the second message may be the second message of block 610 of FIG. 6A, and/or the second message of block 1010 of FIG. 10A. In these aspects, functions described with respect to methods 600 and/or 1000 may be combined with functions of method 1200. For example, the processing of the second message of block 610 may be combined with the processing of the second message discussed here with respect to method 1200.

These aspects may also include transmitting data during the transmission opportunity, and determining whether the data is acknowledged based on the indicated acknowledgment procedure. For example, when an explicit acknowledgment procedure is in use, the data may be determined to be acknowledged when an acknowledgment message is received identifying the data. When implicit acknowledgment procedures are in use, the TXOP owner may determine the data is acknowledged when the data is forwarded by a relay, and the TXOP “overhears” the relay transmission. The TXOP owner may identify the data is being relayed at least in part, on a partial AID in the PLCP header of the relayed/forwarded frame. For example, the partial AID may identify the relay/AP for the forwarded frame.

FIG. 12B is a functional block diagram of an exemplary device 1250 that may be employed within the wireless communication system 100. The device 1250 includes means 1255 for generating a first message, the first message indicating whether permission is granted to relay data transmitted by a first device during a transmission opportunity of the first device. In an embodiment, means 1255 may be configured to perform one or more of the functions discussed above with respect to block 1205. In an embodiment, the means for generating 1255 may include a processor, such as processor 204 of FIG. 2. Means 1255 may also include one or more of a processor, signal generator, transceiver, decoder, or a combination of hardware and/or software component(s), circuits, and/or module(s).

The device 1250 further includes means 1260 for transmitting the first message. In an embodiment, means 1260 may be configured to perform one or more of the functions discussed above with respect to block 1210. The means for transmitting 1260 may include a transmitter, such as transmitter 210 of FIG. 2. Means 1260 may also include one or more of a processor, signal generator, transceiver, decoder, or a combination of hardware and/or software component(s), circuits, and/or module(s).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a data communications medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of data communications medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of wireless communication, comprising:
transmitting, via a first device, a first message, the first message indicating a duration of a transmission opportunity of the first device;
receiving, via the first device, a second message; and
decoding, via the first device, the second message to determine a new duration of the transmission opportunity.

2. The method of claim 1, further comprising generating the first message as one of a request-to-send message, a ps-poll frame, or a trigger frame.

3. The method of claim 1, further comprising decoding the second message as a clear-to-send message, or as a request-to-send message.

4. The method of claim 1, further comprising transmitting a third message indicating whether a second device has permission to extend the duration of the transmission opportunity.

5. The method of claim 1, further comprising generating the first message to indicate whether the first device grants permission to utilize at least a portion of the transmission opportunity to relay data transmitted by the first device.

6. The method of claim 5, further comprising indicating whether the permission is granted in an order field or a relayed frame field of the first message.

7. The method of claim 5, further comprising:
decoding the second message to determine whether an explicit or implicit acknowledgment procedure is used for the relayed data;
transmitting a data packet during the transmission opportunity; and
determining whether the data packet is acknowledged based on the acknowledgment procedure.

8. The method of claim 7, further comprising:
determining a NAV expiration time based on the duration field of the second message;
determining the acknowledgement procedure is explicit if the determined NAV expiration time is different than a NAV expiration time indicated by the duration field of the first message; and
determining the acknowledgment procedure is implicit if the determined NAV expiration time is the same as the NAV expiration time indicated by the duration field of the first message.

9. An apparatus for wireless communication, comprising:
a transmitter configured to transmit a first message, the first message indicating a duration of a transmission opportunity of the apparatus;
a receiver configured to receive a second message; and
a processing system configured to decode the second message to determine a new duration of the transmission opportunity.

10. The apparatus of claim 9, wherein the transmitter is further configured to transmit a third message indicating whether a second device has permission to extend the duration of the transmission opportunity.

11. The apparatus of claim 9, wherein the processing system is further configured to generate the first message to indicate whether the first device grants permission to utilize at least a portion of the transmission opportunity to relay data transmitted by the first device.

12. The apparatus of claim 11, wherein the processing system is further configured to indicate whether the permission is granted in an order field or a relayed frame field of the first message.

13. The apparatus of claim 11, wherein the processing system is further configured to:
decode the second message to determine whether an explicit or implicit acknowledgment procedure is used for the relayed data, and
determine whether a transmitted data packet is acknowledged based on the determined acknowledgment procedure.

14. The apparatus of claim 13, wherein the processing system is further configured to:
determine a NAV expiration time based on the duration field of the second message;
determine the acknowledgement procedure is explicit if the determined NAV expiration time is different than a NAV expiration time indicated by the duration field of the first message; and
determine the acknowledgment procedure is implicit if the determined NAV expiration time is the same as the NAV expiration time indicated by the duration field of the first message.

15. A method of wireless communication, comprising:
receiving, via a first device, a first message;
decoding the first message to determine a duration of a transmission opportunity of a second device;
generating, via the first device, a second message, the second message indicating a new duration of the transmission opportunity; and
transmitting the second message.

16. The method of claim 15, further comprising:
receiving a third message; and
decoding the third message to determine whether the first device has permission to extend the duration of the transmission opportunity.

17. The method of claim 15, further comprising decoding the first message to determine whether permission is granted to relay data transmitted by the second device during the transmission opportunity.

18. The method of claim 17, further comprising:
generating the second message to indicate an acknowledgment procedure for the relayed data;
receiving data from the second device; and
acknowledging the data based on the indicated acknowledgment procedure.

19. The method of claim 18, further comprising:
determining use of an explicit acknowledgment procedure for the received data; and
generating the second message to indicate an extended NAV duration relative to a NAV duration indicated by the first message based on a duration field of the second message.

20. The method of claim 19, further comprising:
determining a duration field of the second message based on an estimated time for a transmission of the data received from the second device, the duration of the transmission opportunity of the second device, and an amount of time remaining in the transmission opportunity; and
indicating the extended NAV duration in the duration field of the second message.

21. The method of claim 18, further comprising:
determining use of an implicit acknowledgment procedure for the received data; and
generating the second message to indicate an unchanged NAV duration relative to a NAV duration indicated by the first message based on a duration field of the second message.

22. The method of claim 18, further comprising transmitting a request-to-send message to a third device in response to receiving the data if the second message indicates an implicit acknowledgment procedure.

23. An apparatus for wireless communication, comprising:
a receiver configured to receive a first message;
a processing system configured to decode the first message to determine a duration of a transmission opportunity of a second device, and to generate a second message indicating a new duration of the transmission opportunity; and
a transmitter configured to transmit the second message.

24. The apparatus of claim 23, wherein the processing system is further configured to decode the first message as one of a request-to-send message, a ps-poll frame, or a trigger frame.

25. The apparatus of claim 23, wherein the processor is further configured to decode the first message to determine whether permission is granted to relay data transmitted by the second device during the transmission opportunity.

26. The apparatus of claim 25, wherein the processor is further configured to:
generate the second message to indicate an acknowledgment procedure for the relayed data;
receive data from the second device; and
acknowledge the data based on the indicated acknowledgment procedure.

27. The apparatus of claim 26, wherein the processor is further configured to:
determine use of an explicit acknowledgment procedure for the received data; and
generate the second message to indicate an extended NAV duration relative to a NAV duration indicated by the first message.

28. The apparatus of claim 27, wherein the processor is further configured to:
determine a duration field of the second message based on an estimated time for a transmission of the data received from the second device, the duration of the transmission opportunity of the second device, and an amount of time remaining in the transmission opportunity, and
indicate the extended NAV duration in the duration field of the second message.

29. The apparatus of claim 26, wherein the processor is further configured to:
determine use of an implicit acknowledgment procedure for the received data, and
generate the second message to indicate an unchanged NAV duration relative to a NAV duration indicated by the first message based on a duration field of the second message.

30. The apparatus of claim 26, wherein the transmitter is further configured to transmit a request-to-send message to a third device in response to receiving the data if the second message indicates an implicit acknowledgment procedure.
